(19) United States
(12) Patent Application Publication
(10) Pub. No.: US 2021/0347999 A1
(43) Pub. Date: Nov. 11, 2021

(54) METHODS FOR BIOBASED DERIVATIZATION OF CELLULOSIC AND SYNTHETIC MATERIALS AND ARTICLES OBTAINED THEREFROM

(71) Applicant: GREENTECH GLOBAL PTE. LTD., Singapore (SG)

(72) Inventors: Jonathan SPENDER, Enfield, ME (US); Michael Albert Bilodeau, Brewer, ME (US)

(73) Assignee: GREENTECH GLOBAL PTE. LTD., Singapore (SG)

(21) Appl. No.: 17/314,826

(22) Filed: May 7, 2021

Related U.S. Application Data
(60) Provisional application No. 63/022,097, filed on May 8, 2020.

(51) Int. Cl. C09D 5/02; C08L 1/02

(52) U.S. Cl. CPC C09D 5/024; C08L 2203/30; C08L 1/02; C09D 5/022

(57) ABSTRACT

The present disclosure relates generally to methods of treating cellulosic or synthetic materials to provide new and/or improved properties, such as water resistance and oil/grease resistance (also referred to as lipophobic and hydrophobic barrier properties), separately or in combination, by using bio-based coatings and/or compositions containing blends of glycerides and/or fatty acid salts, and products obtained by the methods.

### FIELD OF THE DISCLOSURE

The present disclosure relates generally to methods of treating cellulosic or synthetic materials to provide new and/or improved properties, such as water resistance and oil/grease resistance (also referred to as lipophobic and hydrophobic barrier properties), separately or in combination, by using bio-based coatings and/or compositions containing blends of glycerides and/or fatty acid salts, and products obtained by the methods.

### BACKGROUND OF THE DISCLOSURE

Cellulosic materials have a wide range of applications in industry as bulking agents, absorbents, and printing components. Their employment is preferred to that of other sources of material for their high thermal stability, good oxygen barrier function, and chemical/mechanical resilience (see, e.g., Aulin et al., Cellulose (2010) 17:559-574; herein incorporated by reference in its entirety). Of great relevance is also the fact that these materials are fully biodegradable once dispersed in the environment, and that they are totally nontoxic. Cellulose and derivatives thereof are the material of choice for environmentally friendly solutions in applications such as packaging for foodstuff and disposable goods

The many advantages of cellulose are nonetheless countered by the hydrophilicity/lipophilicity of the material, which shows a high affinity for water/fats and are easily hydrated (see, e.g., Aulin et al., Langmuir (2009) 25(13):7675-7685; herein incorporated by reference in its entirety). While this is a benefit for applications such as absorbents and tissues, it becomes an issue when the safe packaging of watery/lipid containing materials (e.g., foodstuffs) is required. Long term storage of food, especially ready-made meals which contain a significant amount of water and/or fat, is made problematic in cellulose trays, for example, as they would first become soggy and then ultimately fail. Further, multiple coatings may be required to offset low efficiency of maintaining sufficient coating on the cellulosic surface due to the high relative porosity of the material, resulting in increased costs.

This problem is usually addressed in the industry by coating the cellulose fiber with some kind of hydrophobic organic material/fluorocarbons, silicones, which would physically shield the underlying hydrophilic cellulose from the water/lipids in the contents, including the prevention of wicking in the fiber interstices, grease flowing into creases, or allowing the release of attached materials. For example, materials such as PVC/PEI/PE are routinely used for this purpose and are physically attached (i.e., spray coated or extruded) on the surfaces to be treated

Industry has utilized compounds based on fluorocarbon chemistry for many years to produce articles having improved resistance to penetration by oil and grease, due to the ability of fluorocarbons to lower the surface energy of the articles. One emerging issue with the use of perfluorinated hydrocarbons is that they are remarkably persistent in the environment. The EPA and FDA have recently begun a review of the source, environmental fate, and toxicity of these compounds. A recent study reported a very high (>90%) rate of occurrence of perfluorooctane sulfonate in blood samples taken from school children. The expense and potential environmental liability of these compounds has driven manufacturers to seek alternative means of producing articles having resistance to penetration by oil and grease.

While lowering the surface energy improves the penetration resistance of the articles, lowering the surface energy also has some disadvantages. For example, a textile fabric treated with a fluorocarbon will exhibit good stain resistance; however, once soiled, the ability of cleaning compositions to penetrate and hence release the soil from the fabric may be affected, which can result in permanently soiled fabrics of reduced useful life. Another example is a greaseproof paper which is to be subsequently printed and/or coated with an adhesive. In this case the requisite grease resistance is attained by treatment with the fluorocarbon, but the low surface energy of the paper may cause problems related to printing ink or adhesive receptivity, including blocking, back trap mottle, poor adhesion, and register. If a greaseproof paper is to be used as a pressure sensitive label having an adhesive applied on one side, the low surface energy may reduce the strength of the adhesion. To improve their printability, coat-ability or adhesion, the low surface energy articles can be treated by post forming processes such as corona discharge, chemical treatment, flame treatment, or the like. However, these processes increase the cost of producing the articles and may have other disadvantages.

It would be desirable to design a “green,” biobased coating which is hydrophobic, lipophobic and compostable, including a base paper/film that would allow for keeping coatings on the surface of said paper and preventing wicking into the fiber interstices, or reducing sticking of materials to the cellulosic surface, at reduced costs, without sacrificing biodegradability and/or recyclability.

Another problem is that synthetic films, such as plastic bags, plastic wraps, plastic containers, etc., are often permeable and require one or more coating layers to achieve oil and grease resistance and/or water resistance, and/or to reduce gas permeability. Again, fluorocarbon- and/or petroleum-based coatings are typically used to provide the synthetic film with the desired barrier properties.

Another problem is that conventional coatings for imparting hydrophobic and/or lipophobic barrier properties, including the fluorocarbon and petrochemical coatings noted herein, is that they tend to perform poorly at the folds, creases, and the like of the article coated with the material. Specifically, the article typically has inferior water resistance and/or grease resistance at these locations. Such a “grease creasing effect” may be defined as the sorption of grease in a paper structure that is created by folding, pressing or crushing said paper structure. A conventional solution to the grease creasing effect is to add a latex, a butadiene, or similar resin to the coating to achieve improved coating coverage at these locations. However, with this conventional solution, the water resistance and/or oil and grease resistance of these locations may still be inferior to the flat portions of the article; this conventional solution increases cost by the addition of the resin component; and this conventional solution is not entirely biobased, since the latex and butadiene may either be synthetic and/or not easily recyclable. Accordingly, there is room for improving the barrier properties of three-dimensional objects having complex or simple shapes with folds, creases and the like.

U.S. Patent Application Publication No. 2018/0066073 (hereinafter “the '073 publication”), which is incorporated herein by reference in its entirety, discloses tunable methods of treating a substrate, in particular cellulosic materials, with a composition that provides increased hydrophobicity and/or lipophobicity without sacrificing the biodegradability thereof. In particular, the '073 application discloses methods of binding of saccharide fatty acid esters (or “SFAE”) on cellulosic materials to provide treated materials that display higher hydrophobicity, lipophobicity, barrier function, and mechanical properties.

### SUMMARY OF THE DISCLOSURE

The various embodiments of the present disclosure provide methods of using a blend of glycerides and/or fatty acid salts to impart oil and grease and/or water resistance to cellulosic and synthetic materials. The various embodiments of the present disclosure also provide articles (or products) obtained by the process, the articles having improved properties, including but not limited to oil and grease and/or water resistance.

In some embodiments, the present disclosure provides a method of imparting hydrophobic and/or lipophobic barrier properties to a substrate, the method including: preparing a formulation for imparting the hydrophobic and/or lipophobic barrier properties to the substrate, the formulation including a blend of one or more glycerides and/or one or more fatty acid salts; and contacting a surface of the substrate with the formulation to impart the hydrophobic and/or lipophobic barrier properties to the substrate. The formulation of the disclosure may also be referred to herein as “the composition,” “the composition of the methods of the disclosure,” “the treatment composition” or the like. The blend of one or more glycerides and/or one or more fatty acid salts may also be referred to as the “glyceride/FAS blend” or the like, and should be inferred as requiring both glyceride and fatty acid salt.

It was unexpected that the formulation comprising one or more fatty acid salts (generally nonpolar and hydrophobic based on their fatty acid chains) and one or more glycerides (generally nonpolar and hydrophobic based on their fatty acid chains; particularly triglycerides, since all of the hydroxyl groups of the glycerol residue are esterified) can be used to impart both water resistance and oil and/grease resistance to a substrate.

In some embodiments the method includes a step of predetermining a content of the glyceride/FAS blend to be included in the formulation. In some aspects, the step of predetermining can be performed prior to the preparing the formulation, or can be performed prior to the contacting the surface of the substrate with the formulation. In some aspects, the step of predetermining is performed to achieve the desired effects. In some aspects, the step of predetermining is performed to achieve a desired level of water resistance and/or a desired level of oil and grease resistance.

In some embodiments, the substrate contacted with the formulation is a cellulosic material, a synthetic polymeric material, or a natural or synthetic woven material. In some embodiments, the cellulosic material can be cellulose fibers, microfibrillated cellulose (MFC), nanofibrillated cellulose, or cellulose nanocrystals.

In some embodiments, the step of contacting the substrate with the formulation includes forming a solution of the formulation and cellulose fiber. This can be referred to as wet end process, because the components of the formulation for imparting the barrier properties (i.e., the glycerides and/or fatty acid salts) are mixed with the cellulose fiber in solution form (as opposed, for example, to coating the surface of a solid material with the formulation). In some embodiments, the solution of the formulation and cellulose fiber is an emulsion. The emulsion can be formed after mixing the formulation and the cellulose fiber, or one or both of the formulation or the cellulose fiber may be in the form of an emulsion prior to their mixing.

In some embodiments, the glyceride/FAS blend is present in the solution at a concentration of at least 0.025% (wt/wt) of the total cellulose fiber present in the solution. In related aspects, the glyceride/FAS blend may be present at about 0.05% (wt/wt) to about 0.1% (wt/wt), about 0.1% (wt/wt) to about 0.5% (wt/wt), about 0.5% (wt/wt) to about 1.0% (wt/wt), about 1.0% (wt/wt) to about 2.0% (wt/wt), about 2.0% (wt/wt) to about 3.0% (wt/wt), about 3.0% (wt/wt) to about 4.0% (wt/wt), about 4.0% (wt/wt) to about 5.0% (wt/wt), about 5.0% (wt/wt) to about 10% (wt/wt), or about 10% (wt/wt) to about 50% (wt/wt) of the total fiber present.

In some embodiments, a saccharide fatty acid ester can be added to the solution as an emulsifier or emulsifying agent, such as to facilitate solubilizing the glycerides, fatty acid salts, and/or the cellulose fiber.

In some embodiments, an article formed using the solution possesses hydrophobic and/or lipophobic barrier properties. The article formed from the solution may include paper, paperboard, bacon board, insulating material, a carton for food storage, a compost bag, a bag for food storage, release paper such as for an adhesive such as a pressure sensitive adhesive, a shipping bag, weed-block/barrier fabric or film, mulching film, plant pots, packing beads, bubble wrap, laminates, envelops, gift cards, credit cards, gloves, raincoats, OGR paper, a shopping bag, diapers, membranes, eating utensil, a tea bag, a container for coffee or tea, a container for holding hot or cold beverages, a cup, a plate, a bottle for carbonated liquid storage, a bottle for non-carbonated liquid storage, a lid, film for wrapping food, a garbage disposal container, a food handling implement, a fabric fibre, a water storage and conveying implement, a storage and conveying implement for alcoholic or non-alcoholic beverages, an outer casing or screen for electronic goods, an internal or external piece of furniture, a curtain, upholstery, fabric, film, a box, a sheet, a tray, a pipe, a water conduit, clothing, a medical device, pharmaceutical packaging, a contraceptive, camping equipment, cellulosic material that is molded, and combinations thereof.

In some embodiments, the step of contacting the substrate with the formulation includes coating the surface of the substrate with the formulation. In some embodiments, the glyceride/FAS blend is present at a coating weight of at least about 0.05 g/m² on the surface of the substrate. In related aspects, the glyceride/FAS blend can be present at a coating weight of about 0.05 g/m² to about 1.0 g/m², about 1.0 g/m² to about 2.0 g/m², about 2 g/m² to about 3 g/m² on a surface of the cellulose-based material. In a related aspect, it may be present from about 3 g/m² to about 4 g/m², about 4 g/m² to about 5 g/m², about 5 g/m² to about 10 g/m², or about 10 g/m² to about 20 g/m².

In some embodiments, the substrate contacted with the formulation is the surface of an article selected from the group consisting of paper, paperboard, bacon board, insulating material, paper pulp, a carton for food storage, a compost bag, a bag for food storage, release paper such as for a pressure sensitive adhesive, a shipping bag, weed-block/barrier fabric or film, mulching film, plant pots, packing beads, bubble wrap, oil absorbent material, laminates, envelops, gift cards, credit cards, gloves, raincoats, OGR paper, a shopping bag, diapers, membranes, eating utensil, a tea bag, a container for coffee or tea, a container for holding hot or cold beverages, a cup, a plate, a bottle for carbonated liquid storage, a bottle for non-carbonated liquid storage, a lid, film for wrapping food, a garbage disposal container, a food handling implement, a fabric fibre, a water storage and conveying implement, a storage and conveying implement for alcoholic or non-alcoholic beverages, an outer casing or screen for electronic goods, an internal or external piece of furniture, a curtain, upholstery, fabric, film, a box, a sheet, a tray, a pipe, a water conduit, clothing, a medical device, pharmaceutical packaging, a contraceptive, camping equipment, cellulosic material that is molded, and combinations thereof.

In some embodiments, the blend of one or more glycerides and/or one or more fatty acid salts are obtained from oilseeds. In other embodiments, the glycerides and/or fatty acid salts are obtained from other sources of naturally occurring, edible fats and oil.

In some embodiments, the one or more glycerides may include a blend of one or more monoglycerides, one or more diglycerides, and one or more triglycerides. The mono-, di-, and triglycerides can be blended in any weight ratio. That is, any one of the mono-, di-, or triglycerides could be the major glyceride component of the formulation by weight. In other embodiments, it is contemplated that the formulation might not include any monoglycerides, or might not include any diglycerides, or might not include any triglycerides.

In some embodiments, the one or more glycerides vary in their fatty acid alkyl groups. For example, the one or more glycerides may contain fatty acid groups having different carbon numbers, different degrees of unsaturation, and/or different configurations and positions of olefins. In some embodiments, the plurality of glycerides include tripalmitin and/or tristearin.

In some embodiments, the one or more fatty acid salts include one or more calcium, potassium or sodium salts. The calcium, potassium or sodium salts of fatty acids can be obtained from a naturally occurring source, such as oil seeds. The one or more fatty acid salts can include one or more selected from sodium oleate, sodium stearate, sodium palmitate, calcium oleate, calcium stearate, or calcium palmitate.

In some embodiments, the hydrophobic barrier property is imparted to the substrate by the blend of one or more glycerides and/or one or more fatty acid salts in the absence of any secondary hydrophobes.

In some embodiments, the formulation used in the methods also includes one or more emulsifiers or emulsifying agents. The one or more emulsifiers can be present in the formulation in a concentration sufficient to form an emulsion of the glycerides and/or fatty acid salts and water. In some embodiments, a weight ratio of the glyceride/FAS blend to the one or more emulsifying agents is from about 0.1:99.9 to about 99.0:0.1, from about 10:90 to about 90:10, from about 20:80 to 80:20, from about 35:65 to 65:35, from about 40:60 to about 60:40, or about 50:50. In some embodiments, the emulsifying agent can be selected from water, buffers, saccharide fatty acid esters, polyvinyl alcohol (PvOH), carboxymethyl cellulose (CMC), milk proteins, wheat glutens, gelatins, prolamines, soy protein isolates, starches, acetylated polysaccharides, alginates, carrageenans, chitosans, inulins, long chain fatty acids, waxes, agar, alginates, glycerol, gums, lecithins, poloxamers, mono-, di-glycerols, monosodium phosphates, monostearate, propylene glycols, detergents, cetyl alcohol, glycerol esters, (saturated) ((poly)unsaturated) fatty acid methyl esters, and combinations thereof.

In some embodiments, the formulation used in the methods also includes one or more saccharide fatty acid esters.

In some embodiments, the one or more saccharide fatty acid esters (SFAE) are added to the formulation to provide the function of an emulsifier. For this purpose, a weight ratio of the glyceride/FAS blend to the one or more SFAE is from about 0.1:99.9 to about 99.0:0.1, from about 10:90 to about 90:10, from about 20:80 to 80:20, from about 35:65 to 65:35, from about 40:60 to about 60:40, or about 50:50.

In some embodiments the method includes a step of predetermining a content of the SFAE to be included in the formulation. In some aspects, this step of predetermining can be performed prior to the preparing the formulation, or can be performed prior to the contacting the surface of the substrate with the formulation. In some aspects, this step of predetermining is performed to achieve the desired effects. In some aspects, the step of predetermining is performed to achieve a desired level of water resistance and/or a desired level of oil and grease resistance. In some embodiments, this step of predetermining can be performed to achieve an emulsion of the glyceride/FAS blend.

In some embodiments, the SFAE may be present in the formulation at a concentration of 10% (wt/wt) to 25% (wt/wt) of the total cellulose fiber present in the solution to provide additional properties discussed below.

In some embodiments, the formulation used in the methods also includes one or more pigments commonly used in the paper industry. The one or more pigments can be present in the formulation in a concentration of about 0.1% to about 90% by weight based on a total weight of the formulation. In other aspects, the concentration of the pigment can be from about 1% to 10% by weight, from about 11% to 20% by weight, from about 21% to 30% by weight, from about 31% to 40% by weight, from about 41% to 50% by weight, 51% to 60% by weight, 61% to 70% by weight, 71 to 80% by weight, 81% to 90% by weight, or any other range between 0.1% to 90% by weight. The use of pigments is well known in the paper industry, and the pigment concentration can be chosen to vary the properties of the final product. In some embodiments, the one or more pigments are selected from clay, calcium carbonate, titanium dioxide, kaolin, talc, or plastic pigment.

In some embodiments, the one or more pigments are pre-treated prior to being included in the formulation. A pre-treatment can include contacting the pigment with the glyceride/FAS blend and/or one or more SFAE according to the methods disclosed herein for a sufficient length of time to bind the glyceride/FAS/SFAE to the pigment. The pre-treated pigment can be included in the wet end (e.g., added directly to the paper-making furnish) or can added to the formulations of the present disclosure.

In some embodiments, the formulation used in the methods is entirely biobased. In some embodiments, the formulation used in the method does not include fluorocarbons. In some embodiments, the formulation used in the method does not include a compound obtained from petroleum. In some embodiments, the articles produced by the methods are entirely biobased.

In some embodiments, the formulation used in the methods includes one or more charged polymers to aid in the retention of the glycerides and/or fatty acid salts on the substrate. The one or more charged polymers may include one or more cationic polymers, anionic polymers, nonionic polymers, and/or zwitterionic polymers. In some embodiments, the charged polymer includes a combination of a relatively low molecular weight cationic polymer and a relative high molecular weight anionic polymer.

In some embodiments, the charged polymer consists of one or more cationic polymer. The one or more cationic polymer may include a polyacrylamide. The polyacrylamide may include polyDADMAC (poly diallyldimethylammonium chloride).

In some embodiments, the cationic polymer has a weight average molecular weight of 500,000 to 10,000,000. In some aspects, the weight average MW is 500,000 to 1,000,000, 1,000,001 to 2,000,000, 2,000,001 to 3,000,000, 3,000,001 to 4,000,000, 4,000,001 to 5,000,000, 5,000,001 to 6,000,000, 6,000,001 to 7,000,000, 7,000,001 to 8,000,000, 8,000,001 to 9,000,000, or 9,000,001 to 10,0000. In some aspects, a blend of charged polymers are used to achieve a “bimodal”-type weight average MW using a combination of charged polymers having any MW in the ranges above (e.g., a first charged polymer having a weight average MW of less than 1,000,000 used in combination with a second charged polymer having a weight average MW greater than 2,000,000; wherein the weight ratio of the first charged polymer to the second charged polymer is 10:90 to 90:10). In some embodiments, a concentration of the cationic polymer in the formulation is from about 0.01% to about 5% by weight, from about 0.01% to about 3% by weight, 0.05% to about 0.1% by weight, or from about 0.1% to about 1% by weight, or from about 1% to about 3% by weight when a total weight of the formulation is considered 100%. In some aspects, a weight ratio in the formulation of the cationic polymer to the glyceride/FAS blend is from about 0.1:99.9 to about 20:80, from 0.5:99.5 to about 15:85, from about 1:99 to about 10:90, or from about 2.5:97.5 to about 7.5:92.5.

While not being bound by any theory, long chain polymers (in particular long chain cationic polymers) may have a tendency to wrap around the ester(s) of the glycerides, which thereby hinders the fatty acid chain of the glyceride. It is hypothesized that one mechanism for achieving the combination of both the oil and grease barrier property and the water barrier property is the increased variance in the planar orientation of the substituted chains (that is, the chains are on different planes).

In some embodiments, the formulation for use in the methods also includes one or more binders selected from starch, protein, prolamine, polymers, polymer emulsions, PvOH, or combinations thereof. In some embodiments, the formulation does not contain a binder.

In some embodiments, the substrate imparted with the hydrophobic and/or lipophobic barrier properties exhibits a 3M grease KIT test value of between about 3 and about 12. In some embodiments, the surface of the substrate imparted with the hydrophobic and/or lipophobic barrier properties exhibits a water contact angle of at least 90°. In some embodiments, the surface of the substrate imparted with the hydrophobic and/or lipophobic barrier properties exhibits an HST value of at least 65 secs.

In some embodiments, an article is provided that is obtained by the disclosed methods.

In some embodiments, an emulsion is provided. The emulsion can be used as the formulation of the methods of the present disclosure. The emulsion can include about 0.01% to about 80% by weight of one or more emulsifiers, about 0.01% to about 95% by weight of a blend of one or more glycerides and/or one or more fatty acid salts, and a balance of water or other suitable solvent. In some embodiments, the emulsion also includes 0.01 to about 3% of a charged polymer as a retention aid. The emulsion may also include material for stabilizing the emulsion over a period of time (e.g., weeks, months, etc.), such as a nano or microfibrilized cellulose, a gum, or a thickening agent. In some embodiments, the one or more emulsifiers includes a saccharide fatty acid ester (SFAE). In some aspects, the content of the SFAE is less than the content of the glyceride/FAS blend (e.g., a weight ratio SFAE:Glyceride/FAS of from 1:99 to 40:60), and in other aspects the content of the SFAE is more than the content of the glyceride/FAS blend (e.g., a weight ratio SFAE:Glyceride/FAS of from 60:50 to 95:5).

In some embodiments, a moldable composition is provided. The moldable composition can include about 75% to about 97% by weight cellulose fiber, and about 2% to about 25% by weight of one or more glycerides, one or more fatty acid salts, and/or one or more saccharide fatty acid esters (SFAE). In some aspects, the moldable composition contains about 2% to about 25% of one or more glycerides. In some aspects, the moldable composition contains about 2% to about 25% of one or more fatty acid salts. In some aspects, the moldable composition contains about 2% to about 25% of one or more SFAE. When the moldable composition includes a combination one or more glycerides and one or more SFAE, the weight ratio glyceride:SFAE may be about 1:99 to about 99:1, about 10:90 to about 90:10, about 20:80 to about 80:20, about 30:70 to about 70:30, about 40:60 to about 60:40 or about 50:50. When the moldable composition includes one or more glycerides, one or more fatty acid salts, and one or more SFAE, the weight ratio the glyceride/FAS blend:SFAE may be about 1:99 to about 99:1, about 10:90 to about 90:10, about 20:80 to about 80:20, about 30:70 to about 70:30, about 40:60 to about 60:40 or about 50:50.

The moldable composition may additionally include a concentration of about 0.1% to about 80% by weight of pigment, when a total weight of the formulation is considered to be 100% by weight. In other aspects, the weight of pigment can be about 1 to 10% by weight, about 11 to 20% by weight, about 21 to 30% by weight, about 41 to 50% by weight, about 51 to 60% by weight, about 61 to 70% by weight, or about 71 to 80% by weight. The content and type of pigment can be selected for varying the properties of a molded article obtained from the moldable composition. For example, clay can be added to enhance the rigidity of the molded article. In some embodiments, the pigment is pre-treated in the manner discussed herein.

In some embodiments, the moldable composition may additionally include one or more emulsifying agents. In some embodiments, a weight ratio of the total weight of glycerides, fatty acid salts and saccharide fatty acid esters to the one or more emulsifying agents is from about 0.1:99.9 to about 99.0:0.1, from about 10:90 to about 90:10, from about 20:80 to 80:20, from about 35:65 to 65:35, from about 40:60 to about 60:40, or about 50:50. In some embodiments, the emulsifying agent can be selected from water, buffers, saccharide fatty acid esters, polyvinyl alcohol (PvOH), carboxymethyl cellulose (CMC), milk proteins, wheat glutens, gelatins, prolamines, soy protein isolates, starches, acetylated polysaccharides, alginates, carrageenans, chitosans, inulins, long chain fatty acids, waxes, agar, alginates, glycerol, gums, lecithins, poloxamers, mono-, di-glycerols, monosodium phosphates, monostearate, propylene glycols, detergents, cetyl alcohol, glycerol esters, (saturated) ((poly)unsaturated) fatty acid methyl esters, and combinations thereof.

In some embodiments, the moldable composition further comprises one or more charged polymers as a retention aid. In some aspects, the charged polymer is the charged polymer defined above for use in the formulations of the present disclosure. In some aspects, a weight ratio in the moldable composition of the cationic polymer to the total weight of glycerides, fatty acid salts, and saccharide fatty acid esters is from about 0.1:99.9 to about 20:80, from 0.5:99.5 to about 15:85, from about 1:99 to about 10:90, or from about 2.5:97.5 to about 7.5:92.5. In some aspects, a content of the charged polymer is 0.01 to 5% by weight based on the total dry weight of the cellulose fiber.

In some embodiments, the moldable composition is flexible, moldable and shapeable when heated to a temperatures of 140° F. or higher, 150° F. or higher, 175° F. or higher, 200° F. or higher, 225° F. or higher, or 250° F. or higher even without the addition of water. The target temperature for achieving flexibility for molding and shaping the composition can be varied, for example, by varying the saccharide fatty acid ester (SFAE). For example, the content of the saccharide fatty acid ester (SFAE) may be varied within the range noted above; the choice of saccharide might be varied (e.g., mono-, di-, and tri, and higher polysaccharides); the substitution of the saccharide may be varied (mono-, di-, tri-, tetra-, penta-, hexa-, hepta-, octa-ester); the length and saturation of the fatty acid chains can be varied; etc. In some aspects, the SFAE is a sucrose fatty acid ester. In some aspects, the SFAE is a xylose fatty acid ester. In some aspects, the SFAE is a glucose fatty acid ester. In some embodiments, the SFAE is a combination of one or more sucrose fatty acid ester, xylose fatty acid ester, and/or glucose fatty acid ester.

The moldable composition of the disclosure unexpectedly possesses hydrophobic and/or lipophobic barrier properties after being heated, molded, and subsequently cooled to ambient temperature. Further, the moldable composition maintains its three dimensional shape (and barrier properties) after being cooled to room temperature. This provides several advantages. For example, the moldable composition can be prepared in bulk and used at a later time to mold a plurality of solid three-dimensional articles (including the exemplary articles listed above), and the solid three-dimensional shape will possess the hydrophobic and/or lipophobic barrier properties.

Another unexpected advantage is that the hydrophobic and/or lipophobic barrier properties can be uniformly possessed over the entirety of the article formed by the moldable composition, including at the folds, creases or the like. In other words, by adding the formulation for imparting the barrier properties on the wet end, a solid three-dimensional product can be obtained having superior barrier properties on both the flat portions and the creases, folds or the like, which is in contrast to the conventional approaches noted above.

Another unexpected advantage is that the use of pigment can be included in the moldable composition without losing the barrier properties. This result was highly unexpected because many inorganic pigments are hydrophilic, and thus not water resistant. In other words, in conventional methods, barrier properties would be lost as the content of inorganic pigment was increased. Accordingly, the methods of the present disclosure beneficially provide articles/products that can be made with a relatively large content of pigment that possess a combination of improved oil and grease resistance and water resistance barrier properties.

In some embodiments, a method of thermal forming a molded article having hydrophobic and/or lipophobic barrier properties is disclosed, the method including: preparing a moldable composition including cellulose fiber, and one or more glycerides, one or more fatty acid salts, and/or one or more saccharide fatty acid esters; heating the moldable composition to a temperature of at least 140° F. to increase the flexibility of the composition; and molding the heated composition into a molded article having a three-dimensional shape, wherein the molded article obtained by the method possesses the hydrophobic and/or lipophobic barrier properties.

In some embodiments, the target temperature for the heating step of the thermal forming methods can be about 140° F. or higher, 150° F. or higher, 175° F. or higher, 200° F. or higher, 225° F. or higher, or 250° F. or higher. The target temperature for achieving flexibility for molding the composition can be varied, for example, by varying the saccharide fatty acid ester. For example, the content of the saccharide fatty acid may be varied within the range noted above; the choice of saccharide might be varied (e.g., mono-, di-, tri, and higher polysaccharides); the substitution of the saccharide may be varied (mono-, di-, tri-, tetra-, penta-, hexa-, hepta-, octa-ester); the length and saturation of the fatty acid chains can be varied; etc. In some aspects, the SFAE is a sucrose fatty acid ester. In some aspects, the SFAE is a xylose fatty acid ester. In some aspects, the SFAE is a glucose fatty acid ester. In some embodiments, the SFAE is a combination of one or more sucrose fatty acid ester, xylose fatty acid ester, and/or glucose fatty acid ester.

In some embodiments, the moldable composition used in the thermal forming methods is the moldable compositions of the present disclosure disclosed above.

In some embodiments, the molded article obtained from the thermal forming methods retains its three-dimensional shape after cooling to ambient temperature (e.g., room temperature of about 68 to about 72 degrees F.). In some embodiments, the molded article obtained from the thermal forming methods is capable of maintaining its three-dimensional shape until being heated again to the temperature range disclosed above. While not being bound by any theory, it is believed that these unexpected properties are achieved by the use of the one or more glycerides, the one or more fatty acid salts, and/or the one or more saccharide fatty acid esters (SFAE) in the disclosed content. For example, it is thought that the heating “melts” the glyceride/FAS/SFAE bound to the cellulose fiber, thereby providing flexibility, and in addition, the barrier properties imparted by the glyceride/FAS/SFAE are retained upon cooling.

In some embodiments, the molded article obtained by the thermal forming methods is selected from paper, paperboard, bacon board, insulating material, a carton for food storage, a compost bag, a bag for food storage, release paper for a pressure sensitive adhesive, a shipping bag, weed-block/barrier fabric or film, mulching film, plant pots, packing beads, bubble wrap, laminates, envelops, gift cards, credit cards, gloves, raincoats, OGR paper, a shopping bag, diapers, membranes, eating utensil, a tea bag, a container for coffee or tea, a container for holding hot or cold beverages, a cup, a plate, a bottle for carbonated liquid storage, a bottle for non-carbonated liquid storage, a lid, film for wrapping food, a garbage disposal container, a food handling implement, a fabric fibre, a water storage and conveying implement, a storage and conveying implement for alcoholic or non-alcoholic beverages, an outer casing or screen for electronic goods, an internal or external piece of furniture, a curtain, upholstery, fabric, film, a box, a sheet, a tray, a pipe, a water conduit, clothing, a medical device, pharmaceutical packaging, a contraceptive, camping equipment, cellulosic material that is molded, or combinations thereof.

In some embodiments, a surface of the molded article obtained from the thermal formal methods exhibits a 3M grease KIT test value of between about 3 and about 12. In some embodiments, a surface of the molded article obtained from the thermal formal methods exhibits a water contact angle of at least 90°. In some embodiments, a surface of the molded article obtained from the thermal formal methods exhibits an HST value of at least 65 secs.

Additional features and advantages of the present disclosure are described further below. This summary section is meant merely to illustrate certain features of the disclosure, and is not meant to limit the scope of the disclosure in any way. The failure to discuss a specific feature or embodiment of the disclosure, or the inclusion of one or more features in this summary section, should not be construed to limit the claims.

### DETAILED DESCRIPTION OF THE DISCLOSURE

Before the present compositions, methods, and methodologies are described in more detail, it is to be understood that the disclosure is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “a glyceride” includes one or more glycerides, and/or compositions of the type described herein which will become apparent to those persons skilled in the art upon reading this disclosure and so forth.

Unless defined otherwise, all technical and scientific terms used herein have the same meaning as commonly understood by one of ordinary skill in the art to which this disclosure belongs. Any methods and materials similar or equivalent to those described herein may be used in the practice or testing of the disclosure, as it will be understood that modifications and variations are encompassed within the spirit and scope of the instant disclosure.

Unless otherwise stated, each range disclosed herein will be understood to encompass and be a disclosure of each discrete point and all possible subranges within the range.

As used herein, “about,” “approximately,” “substantially,” and “significantly” will be understood by a person of ordinary skill in the art and will vary in some extent depending on the context in which they are used. If there are uses of the term which are not clear to persons of ordinary skill in the art given the context in which it is used, “about” and “approximately” will mean plus or minus <10% of particular term, and “substantially” and “significantly” will mean plus or minus >10% of the particular term. “Comprising” and “consisting essentially of” have their customary meaning in the art.

In embodiments, the present disclosure shows that by treating the surface of substrate, such as, for example, cellulose fibers, with a blend of one or more glycerides and/or or more fatty acid salts (or glyceride/FAS blend) the resulting surface is, inter alia, made strongly hydrophobic. For example, in the case of cellulose fiber, the cellulosic hydroxyl groups can be masked by bulky organic chains. Further, the glyceride/FAS blend (and other constituents disclosed herein for facilitating the use of the glycerides and fatty acids, such as, for example, saccharide fatty acid esters), for example, once removed by bacterial enzymes, are easily digested as such. The derivatized surface of the substrate has been shown to display a great deal of heat resistance, being able to withstand temperatures as high as 250° C. and may be more impermeant to gases than the base substrate underneath. The material is therefore an ideal solution to the problem, for example, of derivatizing the hydrophilic surface of cellulose, in any embodiment in which cellulose materials may be employed.

Advantages of the products and methods as disclosed herein include that the coating composition is made from renewable agricultural resources—e.g., vegetable oils; is biodegradable; has a low toxicity profile and suitable for food contact; can be tuned to reduce the coefficient of friction of the substrate (e.g., with regard to a paper/paperboard surface the treatments do not make the paper too slippery for downstream processing or end use), even at high levels of water resistance; may or may not be used with special emulsification equipment or emulsification agents (e.g., a saccharide fatty acid ester); and is compatible with traditional paper recycling programs: i.e., poses no adverse impact on recycling operations, like polyethylene, polylactic acid, or wax coated papers do.

As used herein, “biobased” means a material intentionally made from substances derived from living (or once-living) organisms. In a related aspect, material containing at least about 50% of such substances is considered biobased. However, as noted above, in some embodiments the articles disclosed herein may contain up to 100% of such substances.

As used herein, “bind”, including grammatical variations thereof, means to cohere or cause to cohere essentially as a single mass, and may refer to ionic, hydrophobic, van der Waals interaction, or covalent bonding, or a combination thereof.

As used herein, “cellulosic” means natural, synthetic or semisynthetic materials that can be molded or extruded into objects (e.g., bags, sheets) or films or filaments, which may be used for making such objects or films or filaments, that is structurally and functionally similar to cellulose, e.g., coatings and adhesives (e.g., carboxymethylcellulose). In another example, cellulose, a complex carbohydrate (C₆H₁₀O₅)ₙ that is composed of glucose units, which forms the main constituent of the cell wall in most plants, is cellulosic.

As used herein, “coating weight” is the weight of a material (wet or dry) applied to a substrate. It is expressed in pounds per specified ream or grams per square meter

As used herein, “compostable” means these solid products are biodegradable into the soil.

As used herein, “edge wicking” means the sorption of water in a paper structure at the outside limit of said structure by one or more mechanisms including, but not limited to, capillary penetration in the pores between fibers, diffusion through fibers and bonds, and surface diffusion on the fibers. In a related aspect, the glyceride and/or fatty acid salt containing formulation as described herein prevents edge wicking in treated products. In one aspect, a similar problem exists with grease/oil entering creases that may be present in paper or paper products. Such a “grease creasing effect” may be defined as the sorption of grease in a paper structure that is created by folding, pressing or crushing said paper structure.

As used herein, “effect”, including grammatical variations thereof, means to impart a particular property to a specific material.

As used herein, “hydrophobe” means a substance that does not attract water. For example, waxes, rosins, resins, saccharide fatty acid esters, fatty acid salts, glycerides having long fatty acid chains; di- and triglycerides, diketenes, shellacs, vinyl acetates, PLA, PEI, oils, fats, lipids, other water repellant chemicals or combinations thereof are hydrophobes.

As used herein, “hydrophobicity” means the property of being water-repellent, tending to repel and not absorb water.

As used herein, “lipid resistance” or “lipophobicity” means the property of being lipid-repellent, tending to repel and not absorb lipids, grease, fats and the like. In a related aspect, the grease resistance may be measured by a “3M KIT” test, a TAPPI T559 Kit test, or a Cobb oil test.

As used herein, “cellulose-containing material” or “cellulose-based material” means a composition which consists essentially of cellulose. For example, such material may include, but is not limited to, paper, paper sheets, paperboard, paper pulp, a carton for food storage, parchment paper, cake board, butcher paper, release paper/liner for a pressure sensitive adhesive, a bag for food storage, a shopping bag, a shipping bag, bacon board, insulating material, tea bags, containers for coffee or tea, a compost bag, eating utensil, container for holding hot or cold beverages, cup, a lid, plate, a bottle for carbonated liquid storage, gift cards, a bottle for non-carbonated liquid storage, film for wrapping food, a garbage disposal container, a food handling implement, a fabric fibre (e.g., cotton or cotton blends), a water storage and conveying implement, alcoholic or non-alcoholic drinks, an outer casing or screen for electronic goods, an internal or external piece of furniture, a curtain and upholstery.

As used herein, “release paper” means a paper sheet used to prevent a sticky surface from prematurely adhering to an adhesive or a mastic, such as, for example, for a pressure sensitive adhesive. In one aspect, the coatings as disclosed herein can be used to replace or reduce the use of silicon or other coatings to produce a material having a low surface energy. Determining the surface energy may be readily achieved by measuring contact angle (e.g., Optical Tensiometer and/or High Pressure Chamber, Dyne Testing, Staffordshire, United Kingdom) or by use of Surface Energy Test Pens or Inks (see, e.g., Dyne Testing, Staffordshire, United Kingdom).

As used herein “releasable” with reference to the coating and/or the glyceride/FAS blend means that the coating of glycerides and fatty acid salts, once applied, may be removed from the substrate (e.g., a cellulose-based material), such as by manipulating physical properties). As used herein “non-releasable” with reference to the coating and/or glyceride/FAS blend means that the coating, once applied, is substantially irreversibly bound to the substrate (e.g., cellulose-based material), such as by chemical means.

As used herein, “fibers in solution” or “pulp” means a lignocellulosic fibrous material prepared by chemically or mechanically separating cellulose fibers from wood, fiber crops or waste paper. In a related aspect, where cellulose fibers are treated by the methods as disclosed herein, the cellulose fibers themselves contain bound glyceride/FAS blend as isolated entities, and where the bound cellulose fibers have separate and distinct properties from free fibers (e.g., pulp- or cellulose fiber- or nanocellulose or microfibrillated cellulose-glyceride/fatty acid salt bound material would not form hydrogen bonds between fibers as readily as unbound fibers).

As used herein, “repulpable” means to make a paper or paperboard product suitable for crushing into a soft, shapeless mass for reuse in the production of paper or paperboard.

As used herein, “tunable”, including grammatical variations thereof, means to adjust or adapt a process to achieve a particular result.

As used herein, “water contact angle” means the angle measured through a liquid, where a liquid/vapor interface meets a solid surface. It quantifies the wettability of the solid surface by the liquid. The contact angle is a reflection of how strongly the liquid and solid molecules interact with each other, relative to how strongly each interacts with its own kind. On many highly hydrophilic surfaces, water droplets will exhibit contact angles of 0° to 30°. Generally, if the water contact angle is larger than 90°, the solid surface is considered hydrophobic. Water contact angle may be readily obtained using an Optical Tensiometer (see, e.g., Dyne Testing, Staffordshire, United Kingdom).

As used herein, “water vapour permeability” means breathability or a textile's ability to transfer moisture. There are at least two different measurement methods. One, the MVTR Test (Moisture Vapour Transmission Rate) in accordance with ISO 15496, describes the water vapor permeability (WVP) of a fabric and therefore the degree of perspiration transport to the outside air. The measurements determine how many grams of moisture (water vapor) pass through a square meter of fabric in 24 hours (the higher the level, the higher the breathability).

In one aspect, TAPPI T 530 Hercules size test (i.e., size test for paper by ink resistance) may be used to determine water resistance. Ink resistance by the Hercules method is best classified as a direct measurement test for the degree of penetration. Others classify it as a rate of penetration test. There is no one best test for “measuring sizing.” Test selection depends on end use and mill control needs. This method is especially suitable for use as a mill control sizing test to accurately detect changes in sizing level. It offers the sensitivity of the ink float test while providing reproducible results, shorter test times, and automatic end point determination.

Sizing, as measured by resistance to permeation through or absorption into paper of aqueous liquids, is an important characteristic of many papers. Typical of these are bag, containerboard, butcher's wrap, writing, and some printing grades.

This method may be used to monitor paper or board production for specific end uses provided acceptable correlation has been established between test values and the paper's end use performance. Due to the nature of the test and the penetrant, it will not necessarily correlate sufficiently to be applicable to all end use requirements. This method measures sizing by rate of penetration. Other methods measure sizing by surface contact, surface penetration, or absorption. Size tests are selected based on the ability to simulate the means of water contact or absorption in end use. This method can also be used to optimize size chemical usage costs.

As used herein, “oxygen permeability” means the degree to which a polymer allows the passage of a gas or fluid. Oxygen permeability (Dk) of a material is a function of the diffusivity (D) (i.e., the speed at which oxygen molecules traverse the material) and the solubility (k) (or the amount of oxygen molecules absorbed, per volume, in the material). Values of oxygen permeability (Dk) typically fall within the range 10-150×10⁻¹¹ (cm² ml O₂)/(s ml mmHg). A semi-logarithmic relationship has been demonstrated between hydrogel water content and oxygen permeability (Unit: Barrer unit). The International Organization for Standardization (ISO) has specified permeability using the SI unit hectopascal (hPa) for pressure. Hence Dk=10⁻¹¹ (cm² ml O₂)/(s ml hPa). The Barrer unit can be converted to hPa unit by multiplying it by the constant 0.75.

As used herein “biodegradable”, including grammatical variations thereof, means capable of being broken down especially into innocuous products by the action of living things (e.g., by microorganisms).

As used herein, “recyclable”, including grammatical variations thereof, means a material that is treatable or that can be processed (with used and/or waste items) so as to make said material suitable for reuse.

As used herein, “Gurley second” or “Gurley number” is a unit describing the number of seconds required for 100 cubic centimeters (deciliter) of air to pass through 1.0 square inch of a given material at a pressure differential of 4.88 inches of water (0.176 psi) (ISO 5636-5:2003)(Porosity). In addition, for stiffness, “Gurley number” is a unit for a piece of vertically held material measuring the force required to deflect said material a given amount (1 milligram of force). Such values may be measured on a Gurley Precision Instruments' device (Troy, N.Y.).

HLB—The hydrophilic-lipophilic balance of a surfactant is a measure of the degree to which it is hydrophilic or lipophilic, determined by calculating values for the different regions of the molecule.

Griffin's method for non-ionic surfactants as described in 1954 works as follows:

HLB=20*Mₕ/M

where Mₕ is the molecular mass of the hydrophilic portion of the molecule, and M is the molecular mass of the whole molecule, giving a result on a scale of 0 to 20. An HLB value of 0 corresponds to a completely lipophilic/hydrophobic molecule, and a value of 20 corresponds to a completely hydrophilic/lipophobic molecule.

The HLB value can be used to predict the surfactant properties of a molecule:

<10: Lipid-soluble (water-insoluble)

>10: Water-soluble (lipid-insoluble)

1.5 to 3: anti-foaming agent

3 to 6: W/O (water in oil) emulsifier

7 to 9: wetting and spreading agent

13 to 15: detergent

12 to 16: O/W (oil in water) emulsifier

15 to 18: solubiliser or hydrotrope.

In some embodiments, the HLB values for the glyceride/FAS blend (or composition comprising said ester) as disclosed herein may be in the lower range. In some embodiments, the HLB values for the glyceride/FAS blend (or composition comprising the glyceride/FAS blend) as disclosed herein may be in the middle to higher ranges. In some embodiments, the HLB values for the saccharide fatty acid esters (or composition comprising said ester) as disclosed herein may be in the lower range. In other embodiments, the HLB values for the saccharide fatty acid esters (or composition comprising this ester) as disclosed herein may be in the middle to higher ranges.

As used herein, “SEFOSE®” denotes a sucrose fatty acid ester made from soybean oil (soyate) which is commercially available from Procter & Gamble Chemicals (Cincinnati, Ohio) under the trade name SEFOSE 1618U (see sucrose polysoyate below), which contains one or more fatty acids that are unsaturated. As used herein, “OLEAN®” denotes a sucrose fatty acid ester which is available from Procter & Gamble Chemicals having the formula Cₙ₊₁₂H₂ₙ₊₂₂O₁₃, where all fatty acids are saturated. The Examples of the '073 application, mentioned above and incorporated herein by reference, employed SEFOSE as an SFAE for imparting barrier properties to substrates, including cellulosic materials.

As used herein, “soyate” means a mixture of salts of fatty acids from soybean oil.

As used herein, “oilseed fatty acids” means fatty acids from plants, including but not limited to soybeans, peanuts, rapeseeds, barley, canola, sesame seeds, cottonseeds, palm kernels, grape seeds, olives, safflowers, sunflowers, copra, corn, coconuts, linseed, hazelnuts, wheat, rice, potatoes, cassavas, legumes, camelina seeds, mustard seeds, and combinations thereof. The fatty acid chains of the glycerides and the fatty acid salts can be oilseed fatty acids.

As used herein “wet strength” means the measure of how well a web of fibers holding paper together (or other three-dimensional, solid, cellulose-based product) can resist a force of rupture when the paper is wet. The wet strength may be measured using a Finch Wet Strength Device from Thwing-Albert Instrument Company (West Berlin, N.J.). Where the wet strength is typically effected by wet strength additives such as kymene, cationic glyoxylated resins, polyamidoamine-epichlorohydrin resins, polyamine-epichlorohydrin resins, including epoxide resins. In embodiments, the glyceride/FAS blend coated cellulose-based material as disclosed herein effects such wet strength in the absence of such additives.

As used herein “wet” means covered or saturated with water or another liquid.

In some embodiments, the processes disclosed herein may include a step of binding a glyceride/FAS blend to a cellulosic surface or contacting a cellulosic surface with an emulsion containing the glyceride/FAS blend as a carrier for a coating agent which can bind to a cellulosic surface, where the process comprises contacting a cellulose-based material with either the glyceride/FAS blend, the emulsion or both. The processes may also include an additional binding step comprising exposing the contacted cellulose-based material to heat, radiation, a catalyst or a combination thereof for a sufficient time to bind the glyceride/FAS blend or coating agent to the cellulose based material. In a related aspect, such radiation may include, but is not limited to UV, IR, visible light, or a combination thereof. In another related aspect, the reaction may be carried out at room temperature (i.e., 25° C.) to about 150° C., about 50° C. to about 100° C., or about 60° C. to about 80° C.

Further, the binding reaction between the glyceride/FAS blend and the cellulosic material may be carried out with substantially pure glyceride/FAS blend or may be part of an emulsion. In one aspect, the emulsion may contain a mixture of mono-, di-, tri-, tetra-, penta-, hexa-, hepta-, or octaesters. In another aspect, the emulsion may contain proteins, polysaccharides and lipids, including but not limited to, milk proteins (e.g., casein, whey protein and the like), wheat glutens, gelatins, prolamines (e.g., corn zeins), soy protein isolates, starches, modified starches, acetylated polysaccharides, alginates, carrageenans, chitosans, inulins, long chain fatty acids, waxes, and combinations thereof.

In embodiments, the emulsion may be mixed with epoxy derivatives of said esters (see, e.g., U.S. Pat. No. 9,096,773, herein incorporated by reference in its entirety), where such epoxy derivatives may function, for example, as adhesives.

In embodiments, cellulosic material may be made lipophobic by the addition of polyvinyl alcohol (PvOH) and/or prolamines. In one aspect, the prolamines include zein, gliadin, hordein, secalin, katirin and avenin. In a related aspect, the prolamine is zein.

In embodiments, no catalysts and no organic carriers (e.g., volatile organic compounds) are required to carry out the binding reaction, including that no build-up of material is contemplated using the method as disclosed. In a related aspect, the reaction time is substantially instantaneous (i.e., less than 1 second). Further, the resulting material exhibits low blocking.

In some embodiments, the substrate can be a synthetic film or synthetic woven material made from a polymer, such as but not limited to polyethylene, polypropylene, PVC, polycarbonate, polyester, PVDC, polyamide, polylactic acid, polybutylene succinate, polyhydroxyalkanoate, or 1,4 butanediol. The formulation can be applied to synthetic polymer film to impart the effects described herein. Using the formulations to impart the effects avoids the conventional use of chlorofluorocarbons and petroleum based compounds to provide one or more of improved oil and grease resistance, water resistance, and gas and vapor barrier properties.

The use of a synthetic polymeric film as the substrate may require the use of an additional adhesive component or an adhesive layer between the substrate and the coatings described herein to adhere the coating to the substrate. Exemplary materials for such an adhesive component or adhesive layer can include, for example, polyvinyl alcohol, latex or blends thereof.

The glycerides and fatty acid salts suitable for use in the glyceride/FAS blend of the present disclosure are well known in the art and are not particularly limited. It will be apparent to one of skill in the art from the entirety of the disclosure and its examples that they may be varied depending on the property(ies) desired for the final product.

The term “glycerides” as used herein has its common meaning and refers to acylglycerols, which are esters formed from glycerol and fatty acids. Glycerol has three hydroxyl functional groups, which can be esterified with one, two, or three fatty acids to form mono-, di-, and triglycerides. These structures can vary in their aliphatic chain as they can contain different carbon numbers, different degrees of unsaturation, and different configurations and positions of olefins.

The glycerides may be obtained by esterification with substantially pure fatty acids by known processes of esterification. The glycerides can also be extracted from plant oils and animal fats by known methods of extraction.

The term “fatty acid” as used herein has its common meaning and refers to a carboxylic acid with an aliphatic chain, which may be saturated or unsaturated. The term fatty acid as used herein may refer to the fatty acid group bound to the glycerol residue of the glyceride.

The fatty acid groups of the glycerides can be any known fatty acid. In preferred embodiments, the fatty acid is known to be present in food, is edible, and/or is approved by the FDA. In some embodiments, the fatty acids are obtained from oilseeds. In other embodiments, the fatty acids are obtained from other sources of naturally edible fats and oil.

The fatty acids of the glycerides can be independently selected from one or more saturated fatty acids, one or more monounsaturated fatty acids, and/or one or more polyunsaturated fatty acids. By independently, this means, for example, that a triglyceride may comprise three different fatty acid groups attached to the glycerol residue.

Exemplary saturated fatty acids for use in the formulations/compositions of the disclosure can be selected from butyric acid (butanoic acid), caproic acid (hexanoic acid), caprylic acid (octanoic acid), capric acid (decanoic acid), lauric acid, (dodecanoic acid), myristic acid (tetradecanoic acid), palmitic acid (hexadecanoic acid), stearic acid (octadecanoic acid), arachidic acid (icosanoic acid), behenic acid (docosanoic acid), or lignoceric acid (tetracosanoic acid).

Exemplary monounsaturated fatty acids for use in the formulations/compositions of the disclosure can be selected from caproleic acid, (dec-9-enoic acid), lauroleic acid ((Z)-dodec-9-enoic acid), myristoleic acid ((Z)-tetradec-9-enoic acid), palmitoleic acid ((Z)-hexadec-9-enoic acid), oleic acid ((Z)-octadec-9-enoic acid), elaidic acid ((E)-octadec-9-enoic acid), vaccenic acid ((E)-octadec-11-enoic acid), gadoleic acid ((Z)-icos-9-enoic acid), erucic acid ((Z)-docos-13-enoic acid), brassidic acid ((E)-docos-13-enoic acid), or nervonic acid ((Z)-tetracos-15-enoic acid).

Exemplary polyunsaturated fatty acids for use in the formulations/compositions of the disclosure can be selected from linoleic acid (LA) ((9Z,12Z)-octadeca-9,12-dienoic acid), alpha-Linolenic acid (ALA) ((9Z,12Z,15Z)-octadeca-9,12,15-trienoic acid), gamma-Linolenic acid (GLA) ((6Z,9Z,12Z)-octadeca-6,9,12-trienoic acid), columbinic acid ((5E,9E,12E)-octadeca-5,9,12-trienoic acid), stearidonic acid ((6Z,9Z,12Z,15Z)-octadeca-6,9,12,15-tetraenoic acid), mead acid ((5Z,8Z,11Z)-icosa-5,8,11-trienoic acid), dihomo-γ-linolenic acid (DGLA) ((8Z,11Z,14Z)-icosa-8,11,14-trienoic acid), arachidonic acid ((5Z,8Z,11Z,14Z)-icosa-5,8,11,14-tetraenoic acid), eicosapentaenoic acid (EPA) ((5Z,8Z,11Z,14Z,17Z)-icosa-5,8,11,14,17-pentaenoic acid), docosapentaenoic acid (DPA) ((7Z,10Z,13Z,16Z,19Z)-docosa-7,10,13,16,19-pentaenoic acid), docosahexaenoic acid (DHA) ((4Z,7Z,10Z,13Z,16Z,19Z)-docosa-4,7,10,13,16,19-hexaenoic acid).

In some embodiments, the one or more glycerides may include a blend of one or more monoglycerides, one or more diglycerides, and/or one or more triglycerides. In this regard, the mono-, di-, and triglycerides can be blended in any weight ratio. That is, any one of the mono-, di-, or triglycerides could be the major glyceride component of the formulation by weight (that is, greater than 50% by weight when a total weight of glycerides is considered to be 100% by weight). In other embodiments, the formulation does not include a monoglyceride; does not include a diglyceride; or does not include a triglyceride.

In some embodiments, the glycerides may include a combination of one or more water insoluble glycerides (e.g., as noted above, triglycerides are typically strongly nonpolar and hydrophobic) and one or more water soluble glycerides (in any weight ratio from 0.1:99.9 to 99.9:0.1); or only insoluble glycerides; or only insoluble glycerides. The solubility of the glyceride can be determined, for example, by its HLB value.

A person of skill in the art will appreciate that the HLB value of the one or more glycerides can be selected by varying one or more of the parameters of the glycerides noted above. In this regard, when a plurality of glycerides are used, each glyceride may have be chosen to have similar or different HLB values (e.g., lower range used in combination with higher range).

The term “fatty acid salt” as used herein has its common meaning and refers to a salt of any one or more of the fatty acids disclosed herein above. Exemplary cations for the fatty acid salts include but are not limited to calcium, potassium, and sodium salts. The fatty acid salts can be synthesized by known methods or extracted from plant oils or animal fats by known methods. One exemplary process comprises adding sodium hydroxide to fatty acids found in animal fats or plant oils (such as from oilseeds). For example, sodium palmitate can be obtained from palm oil.

In some embodiments, the glyceride/FAS blend may contain only one or more glycerides, may contain only one or more fatty acid salts, or may contain both one or more glycerides and one or more fatty acid salts. When the glyceride/FAS blend contains both one or more glycerides and one or more fatty acids, the weight ratio of glycerides to fatty acid salts can be from about 0.1:99.9 to about 99:0.1, from about 10:90 to about 90:10, from about 20:80 to about 80:20, from about 35:65 to about 65:35, from about 40:60 to about 60:40, from about 45:55 to about 55:45, or about 50:50.

While not being bound by theory, the interaction between the glyceride/FAS blend and the cellulose-based material may be by ionic, hydrophobic, van der Waals interaction, or covalent bonding, or a combination thereof. In a related aspect, the glyceride/FAS blend binding to the cellulose-based material is substantially irreversible (e.g., using a glyceride or fatty acid salt comprising a combination of saturated and unsaturated fatty acids).

In some embodiments, the hydrophobic barrier property is imparted to the substrate by the glyceride/FAS blend in the absence of any secondary hydrophobes.

Further, at a sufficient concentration, the binding of the glyceride/FAS blend alone is enough to make the contacted substrate hydrophobic: i.e., hydrophobicity is achieved in the absence of the addition of waxes, rosins, resins, diketenes, shellacs, vinyl acetates, PLA, PEI, oils, other water repellant chemicals or combinations thereof (i.e., secondary hydrophobes), including that other properties such as, inter alia, strengthening, stiffing, and bulking of the cellulose-based material is achieved by glyceride/fatty acid salt binding alone.

An advantage of the present disclosure is that multiple fatty acid chains are reactive with the cellulose. This is thought to give rise to a crosslinking network, leading to strength improvements in fibrous webs such as paper, paperboard, air-laid and wet-laid non-wovens, and textiles. This is typically not found in other sizing or hydrophobic treatment chemistries. The glycerides and fatty acid salts as disclosed herein also generate/increase wet strength, a property absent when using many other water resistant chemistries.

Saturated glycerides and fatty acid salts are typically solids at nominal processing temperatures, whereas unsaturated glycerides and fatty acid salts are typically liquids. This permits the formation of uniform, stable dispersions of saturated glycerides and fatty acid salts in aqueous coatings without significant interactions or incompatibilities with other coating components, which are typically hydrophilic. In addition, this dispersion allows for high concentrations of saturated glycerides and fatty acid salts to be prepared without adversely affecting coating rheology, uniform coating application, or coating performance characteristics. The coating surface will become hydrophobic when the particles of saturated glycerides and fatty acid salts melt and spread upon heating, drying and consolidation of the coating layer.

In embodiments, the amount of the glyceride/FAS blend used to impart hydrophobicity depends on the form of the substrate (e.g., the form of the cellulose-based material) and the method of contacting the surface of the substrate. In one aspect, when the glyceride/FAS blend is bound as a coating on the cellulose-based material, the glyceride/FAS blend is present at a coating weight of at least about 0.05 g/m² to about 1.0 g/m², about 1.0 g/m² to about 2.0 g/m², about 2 g/m² to about 3 g/m² on a surface of the cellulose-based material. In a related aspect, it may be present from about 3 g/m² to about 4 g/m², about 4 g/m² to about 5 g/m², about 5 g/m² to about 10 g/m², about 10 g/m² to about 20 g/m². In another aspect, when the cellulose-based material is a solution containing cellulose fiber, the glyceride/FAS blend is present at a concentration of at least about 0.025% (wt/wt) of the total fiber present. In a related aspect, it may be present at about 0.05% (wt/wt) to about 0.1% (wt/wt), about 0.1% (wt/wt) to about 0.5% (wt/wt), about 0.5% (wt/wt) to about 1.0% (wt/wt), about 1.0% (wt/wt) to about 2.0% (wt/wt), about 2.0% (wt/wt) to about 3.0% (wt/wt), about 3.0% (wt/wt) to about 4.0% (wt/wt), about 4.0% (wt/wt) to about 5.0% (wt/wt), about 5.0% (wt/wt) to about 10% (wt/wt), about 10% (wt/wt) to about 50% (wt/wt) of the total fiber present. In a further related aspect, the amount of the glyceride/FAS blend may be equal to the amount of fiber present. In some embodiments, the glyceride/FAS blend may coat the entire outer surface of a cellulose-based material (e.g., coat an entire piece of paper or cellulose-containing article).

In other embodiments, a coating may comprise between about 0.9% to about 1.0%, about 1.0% to about 5.0%, about 5.0 to about 10%, about 10% to about 20%, about 20% to about 30%, about 40% to about 50% of the glyceride/FAS blend by weight of the coating (wt/wt).

In embodiments, a method of producing bulky, fibrous structures that retain strength even when exposed to water is disclosed. Generally fibrous slurries that are dried form dense structures that are easily broken down upon exposure to water. Formed fiber products made using the method as disclosed may include paper plates, drink holders (e.g., cups), lids, food trays and packaging that would be light weight, strong, and be resistant to exposure to water and other liquids.

In embodiments, the glyceride/FAS blend can be mixed with polyvinyl alcohol (PvOH) to produce sizing agents for water resistant coatings. A synergistic relationship between glycerides and fatty acid salts and PvOH has been demonstrated. While it is known in the art that PvOH is itself a good film former, and forms strong hydrogen bonds with cellulose, it is not very resistant to water, particularly hot water. In aspects, the use of PvOH helps to emulsify glycerides and fatty acid salts into an aqueous coating. In one aspect, PvOH provides a rich source of OH groups for the glycerides to crosslink along the fibers, which increases the strength of paper, for example, particularly wet strength, and water resistance beyond what is possible with PvOH alone. For mono- and diglycerides with free hydroxyls on the glycerol residue, a crosslinking agent such as a dialdehyde (e.g., glyoxal, glutaraldehyde, and the like) may also be used.

In other aspects, the effect of the glyceride/FAS blend can be enhanced by the addition of one or more saccharide fatty acid esters (SFAE). As disclosed herein, fatty acid esters of all saccharides, including mono-, di-saccharides and tri-saccharides, are adaptable for use in connection with aspects of the present disclosure, which include its use an emulsifier. In a related aspect, the saccharide fatty acid ester may be a mono-, di-, tri-, tetra-, penta-, hexa-, hepta-, or octaester, and combinations thereof, including that the fatty acid moieties may be saturated, unsaturated or a combination thereof.

While not being bound by theory, the interaction between the saccharide fatty acid ester and the cellulose-based material may be by ionic, hydrophobic, van der Waals interaction, or covalent bonding, or a combination thereof. In a related aspect, the saccharide fatty acid ester binding to the cellulose-based material is substantially irreversible (e.g., using an SFAE comprising a combination of saturated and unsaturated fatty acids).

An advantage of additionally using saccharide fatty acid esters is that they also contain multiple fatty acid chains reactive with the cellulose. Moreover, the two saccharide molecules in the structure of, for example, the sucrose fatty acid esters as disclosed give rise to a stiff crosslinking network, leading to strength improvements in fibrous webs such as paper, paperboard, air-laid and wet-laid non-wovens, and textiles. This is typically not found in other sizing or hydrophobic treatment chemistries. The saccharide fatty acid esters as disclosed herein can also generate/increase wet strength, particularly when used in combination with the glyceride/FAS blend, a property absent when using many other water resistant chemistries.

Another advantage of additionally using saccharide fatty acid esters is that they can limit hydrogen bonding between cellulosic fibers, increasing the space between them, thus, increasing bulk without substantially increasing weight.

When used in the embodiments, the saccharide fatty acid esters may comprise or consist essentially of sucrose esters of fatty acids. Many methods are known and available for making or otherwise providing the saccharide fatty acid esters of the present invention, and all such methods are believed to be available for use within the broad scope of the present disclosure. For example, in certain embodiments it may be preferred that the fatty acid esters are synthesized by esterifying a saccharide with one or more fatty acid moieties obtained from oil seeds including but not limited to, soybean oil, sunflower oil, olive oil, canola oil, peanut oil, and mixtures thereof.

In embodiments, the saccharide fatty acid esters comprise a saccharide moiety, including but not limited to a sucrose moiety, which has been substituted by an ester moiety at one or more of its hydroxyl hydrogens. In a related aspect, disaccharide esters for use in this disclosure can have the structure of Formula I of the '073 publication, which is incorporated herein by reference.

Suitable disaccharides for the saccharide fatty esters may also include xylose, glucose, raffinose, maltodextrose, galactose, combinations of glucose, combinations of fructose, maltose, lactose, combinations of mannose, combinations of erythrose, isomaltose, isomaltulose, trehalose, trehalulose, cellobiose, laminaribiose, chitobiose and combinations thereof.

In other embodiments, a starch fatty acid ester as disclosed by the '073 publication can be used, where the starch may be derived from any suitable source such as dent corn starch, waxy corn starch, potato starch, wheat starch, rice starch, sago starch, tapioca starch, sorghum starch, sweet potato starch, and mixtures thereof.

For use in the compositions of the present disclosure, the saccharide fatty acid ester compounds may have a high degree of substitution. In some embodiments, the saccharide fatty acid ester is a sucrose polysoyate.

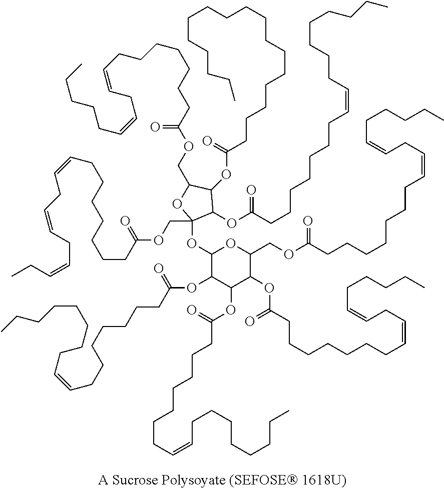 [SMILES: CC/C=C\C/C=C\C/C=C\CCCCCCCC(=O)OCC1(OC2OC(COC(=O)CCCCCCC/C=C\C/C=C\CCCCC)C(OC(=O)CCCCCCC/C=C\C/C=C\CCCCC)C(OC(=O)CCCCCCC/C=C\CCCCCCCC)C2OC(=O)CCCCCCC/C=C\CCCCCCCC)OC(COC(=O)CCCCCCC/C=C\C/C=C\CCCCC)C(OC(=O)CCCCCCCCCCCCCCCCC)C1OC(=O)CCCCCCC/C=C\CCCCCCCC]

When used in the present disclosure, the saccharide fatty acid esters can be produced in the manner disclosed in the '073 application. For example, saccharide fatty acid esters may be made by esterification with substantially pure fatty acids by known processes of esterification. They can be prepared also by trans-esterification using saccharide and fatty acid esters in the form of fatty acid glycerides derived, for example, from natural sources, for example, those found in oil extracted from oil seeds, for example soybean oil. Trans-esterification reactions providing sucrose fatty acid esters using fatty acid glycerides are described, for example, in U.S. Pat. Nos. 3,963,699; 4,517,360; 4,518,772; 4,611,055; 5,767,257; 6,504,003; 6,121,440; and 6,995,232, and International Publication WO1992004361, herein incorporated by reference in their entireties

In embodiments, the saccharide fatty acid ester may be present in different concentrations in combination with the glyceride/FAS blend to impart hydrophobicity depending on the form of the cellulose-based material. In one aspect, when a saccharide fatty acid ester (SFAE) is bound as a coating on the cellulose-based material, the SFAE is present at a coating weight of at least about 0.05 g/m² to about 1.0 g/m², about 1.0 g/m² to about 2.0 g/m², about 2 g/m² to about 3 g/m² on a surface of the cellulose-based material. In a related aspect, it may be present from about 3 g/m² to about 4 g/m², about 4 g/m² to about 5 g/m², about 5 g/m² to about 10 g/m², about 10 g/m² to about 20 g/m². In another aspect, when the cellulose-based material is a solution containing cellulose fiber, the SFAE is present at a concentration of at least about 0.025% (wt/wt) of the total fiber present. In a related aspect, it may be present at about 0.05% (wt/wt) to about 0.1% (wt/wt), about 0.1% (wt/wt) to about 0.5% (wt/wt), about 0.5% (wt/wt) to about 1.0% (wt/wt), about 1.0% (wt/wt) to about 2.0% (wt/wt), about 2.0% (wt/wt) to about 3.0% (wt/wt), about 3.0% (wt/wt) to about 4.0% (wt/wt), about 4.0% (wt/wt) to about 5.0% (wt/wt), about 5.0% (wt/wt) to about 10% (wt/wt), about 10% (wt/wt) to about 50% (wt/wt) of the total fiber present. In a further related aspect, the amount of SFAE may be equal to the amount of fiber present. In some embodiments, the SFAE may coat the entire outer surface of a cellulose-based material (e.g., coat an entire piece of paper or cellulose-containing article).

In other embodiments, a coating may comprise between about 0.9% to about 1.0%, about 1.0% to about 5.0%, about 5.0 to about 10%, about 10% to about 20%, about 20% to about 30%, about 40% to about 50% saccharide fatty acid ester by weight of the coating (wt/wt). In a related aspect, the SFAE may be present in the formulation at a concentration of 5% (wt/wt) to 25% (wt/wt) of the total cellulose fiber present in the solution to provide additional properties discussed below in relation to a thermal forming method.

In embodiments, the cellulose-based material includes, but is not limited to, paper, paperboard, paper sheets, paper pulp, cups, boxes, trays, lids, release papers/liners, compost bags, shopping bags, shipping bags, bacon board, tea bags, insulating material, containers for coffee or tea, pipes and water conduits, food grade disposable cutlery, plates and bottles, screens for TV and mobile devices, clothing (e.g., cotton or cotton blends), bandages, pressure sensitive labels, pressure sensitive tape, feminine products, and medical devices to be used on the body or inside it such as contraceptives, drug delivery devices, container for pharmaceutical materials (e.g., pills, tablets, suppositories, gels, etc.), and the like. Also, the coating technology as disclosed may be used on furniture and upholstery, outdoors camping equipment and the like.

In one aspect, the coatings as described herein are resistant to pH in the range of between about 3 to about 9. In a related aspect, the pH may be from about 3 to about 4, about 4 to about 5, about 5 to about 7, about 7 to about 9.

In embodiments, a method for treating a surface of a cellulose containing (or cellulosic) material is disclosed including applying to the surface a composition containing an alkanoic acid derivative having the formula (II) or (III):

R—CO—X Formula (II)

X—CO—R—CO—X₁ Formula (III),

where R is a straight-chain, branched-chain, or cyclic aliphatic hydrocarbon radical having from 6 to 50 carbon atoms, and where X and X₁ are independently Cl, Br, R—CO—O—R, or O(CO)OR, where when the alkanoic acid derivative comprises formula (III) X or X₁ is the same or is different, where the glyceride/FAS blend as disclosed herein is a carrier, and where the method does not require an organic base, gaseous HCl, VOCs or catalyst.

In embodiments, an alkanoic acid derivative is mixed with glycerides and/or fatty acid salts to form an emulsion, where the emulsion is used to treat the cellulose-based material.

In embodiments, a saccharide fatty acid ester (SFAE) may be used as an emulsifying agent and may comprise a mixture of one or more mono-, di-, tri-, tetra-, penta-, hexa-, hepta-, or octaesters. In another aspect, the fatty acid moiety of the saccharide fatty acid ester may contain saturated groups, unsaturated groups or a combination thereof. In one aspect, the saccharide fatty acid ester-containing emulsion may also contain proteins, polysaccharides and/or lipids, including but not limited to, milk proteins (e.g., casein, whey protein and the like), wheat glutens, gelatins, prolamines (e.g., corn zein), soy protein isolates, starches, acetylated polysaccharides, alginates, carrageenans, chitosans, inulins, long chain fatty acids, waxes, and combinations thereof.

In embodiments, the saccharide fatty acid ester (SFAE) emulsifiers as disclosed herein may be used to carry coatings or other chemicals used for paper manufacturing including but not limited to the glyceride/FAS blend, agalite, esters, diesters, ethers, ketones, amides, nitriles, aromatics (e.g., xylenes, toluenes), acid halides, anhydrides, talc, alkyl ketene dimer (AKD), alabaster, alganic acid, alum, albarine, glues, barium carbonate, barium sulfate, chlorine dioxide, clays, dolomite, diethylene triamine penta acetate, EDTA, enzymes, formamidine sulfuric acid, guar gum, gypsum, lime, magnesium bisulfate, milk of lime, milk of magnesia, polyvinyl alcohol (PvOH), rosins, rosin soaps, satins, soaps/fatty acids, sodium bisulfate, soda-ash, titania, surfactants, starches, modified starches, hydrocarbon resins, polymers, waxes, polysaccharides, proteins, and combinations thereof.

In some embodiments, the formulation used in the methods of the disclosure includes one or more charged polymers to aid in the retention of the one or more glycerides and/or one or more fatty acid salts on the substrate. As explained above, the charged polymer is thought to aid in imparting the effects (e.g., barrier properties including oil and grease resistance and water resistance) by aligning the fatty acid groups of the glyceride/FAS blend. When the formulation additionally includes one or more saccharide fatty acid ester (SFAE), the retention aid is also thought to facilitate alignment of the fatty acid groups of the SFAEs to aid in imparting the effects.

The one or more charged polymers may include one or more cationic polymers, anionic polymers, nonionic polymers, and/or zwitterionic polymers. In some embodiments, a concentration of the cationic polymer in the formulation is from about 0.01% to about 5% by weight, from about 0.01% to about 3% by weight, 0.05% to about 0.1% by weight, or from about 0.1% to about 1% by weight, or from about 1% to about 3% by weight when a total weight of the formulation is considered 100%. In some aspects, a weight ratio in the formulation of the cationic polymer to the glyceride/FAS blend is from about 0.1:99.9 to about 20:80, from 0.5:99.5 to about 15:85, from about 1:99 to about 10:90, or from about 2.5:97.5 to about 7.5:92.5.

In other embodiments, a weight ratio of the cationic polymer to a total of the glyceride/FAS blend and the saccharide fatty acid ester (SFAE) in the formulation (formulation:(blend+SFAE)) is from about 0.1:99.9 to about 20:80, from 0.5:99.5 to about 15:85, from about 1:99 to about 10:90, or from about 2.5:97.5 to about 7.5:92.5.

In some embodiments, the charged polymer has a weight average molecular weight of 500,000 to 10,000,000. In some embodiments, the weight average MW is 500,000 to 1,000,000, 1,000,001 to 2,000,000, 2,000,001 to 3,000,000 etc. In some embodiments, the charged polymer is a combination of two polymers having different weight average MW to achieve a bimodal-type blend.

Exemplary cationic polymers for use as the retention aid include but is not limited to polyacrylamide (e.g., polyDADMAC (poly diallyldimethylammonium chloride)), poly(ethyleneimine) (PEI), poly-l-(lysine) (PLL), poly[2-(N,N-dimethylamino)ethyl methacrylate] (PDMAEMA), and chitosan.

In embodiments, the coated material (e.g., cellulose-containing material) generated by the methods as disclosed herein exhibits greater hydrophobicity or water-resistance relative to the cellulose-containing material without the treatment. In a related aspect, the treated cellulose-containing material exhibits greater lipophobicity or grease resistance relative to the cellulose-containing material without the treatment. In a further related aspect, the treated cellulose-containing material may be biodegradable, compostable, and/or recyclable. In one aspect, the treated cellulose-containing material is both hydrophobic (water resistant) and lipophobic (grease resistant).

In embodiments, the treated substrate may have improved mechanical properties compared to that same material untreated. For example, paper bags treated by the process as disclosed herein show increased burst strength, Gurley Number, Tensile Strength and/or Energy of Maximum Load. In one aspect, the burst strength is increased by a factor of between about 0.5 to 1.0 fold, between about 1.0 and 1.1 fold, between about 1.1 and 1.3 fold, between about 1.3 to 1.5 fold. In another aspect, the Gurley Number increased by a factor of between about 3 to 4 fold, between about 4 to 5 fold, between about 5 to 6 fold and about 6 to 7 fold. In still another aspect, the Tensile Strain increased by a factor of between about 0.5 to 1.0 fold, between about 1.0 to 1.1 fold, between about 1.1 to 1.2 fold and between about 1.2 to 1.3 fold. And in another aspect, the Energy of Max Load increased by a factor of between about 1.0 to 1.1 fold, between about 1.1 to 1.2 fold, between about 1.2 to 1.3 fold, and between about 1.3 to 1.4 fold

In embodiments, the cellulose-containing material is a base paper comprising microfibrillated cellulose (MFC) or cellulose nanofiber (CNF) as described for example in U.S. Pub. No. 2015/0167243 (herein incorporated by reference in its entirety), where the MFC or CNF is added during the forming process and paper making process and/or added as a coating or a secondary layer to a prior forming layer to decrease the porosity of said base paper. In a related aspect, the base paper is contacted with the glyceride/FAS blend formulations as described above. In a further related aspect, the contacted base paper is further contacted with a polyvinyl alcohol (PvOH). In embodiments, the resulting contacted base paper is tuneably water and lipid resistant. In a related aspect, the resulting base paper may exhibit a Gurley value of at least about 10-15 (i.e., Gurley Air Resistance (sec/100 cc, 20 oz. cyl.)), or at least about 100, at least about 200 to about 350. In one aspect, the glyceride/FAS blend coating may be a laminate for one or more layers or may provide one or more layers as a laminate or may reduce the amount of coating of one or more layers to achieve the same performance effect (e.g., water resistance, grease resistance, and the like). In a related aspect, the laminate may comprise a biodegradable and/or composable heat seal or adhesive.

In embodiments, the glyceride/FAS blend may be formulated as emulsions, where the choice emulsifying agent and the amount employed is dictated by the nature of the composition and the ability of the agent to facilitate the dispersion of the saccharide fatty acid ester. In one aspect, the emulsions are used in the methods of the present disclosure. In one aspect, the emulsifying agents may include, but are not limited to, water, buffers, saccharide fatty acid esters, polyvinyl alcohol (PvOH), carboxymethyl cellulose (CMC), milk proteins, wheat glutens, gelatins, prolamines, soy protein isolates, starches, acetylated polysaccharides, alginates, carrageenans, chitosans, inulins, long chain fatty acids, waxes, agar, alginates, glycerol, gums, lecithins, poloxamers, mono-, di-glycerols, monosodium phosphates, monostearate, propylene glycols, detergents, cetyl alcohol, glycerol esters, (saturated) ((poly)unsaturated) fatty acid methyl esters (e.g., methyl stearate, methyl palmitate, methyl palmitoleate (cis-9)), and combinations thereof. In another aspect, a weight ratio of the glyceride/FAS blend to the one or more emulsifying agents is from about 0.1:99.9 to about 99.0:0.1, from about 10:90 to about 90:10, from about 20:80 to 80:20, from about 35:65 to 65:35, from about 40:60 to about 60:40, or about 50:50. It will be apparent to one of skill in the art that ratios may be varied depending on the property(ies) desired for the final product.

In embodiments, the glyceride/FAS blend may be combined with one or more coating components for internal and surface sizing (alone or in combination), including but not limited to, pigments (e.g., clay, calcium carbonate, titanium dioxide, plastic pigment), binders (e.g., starch, soy protein, polymer emulsions, PvOH, casein), and additives (e.g., glyoxal, glyoxalated resins, zirconium salts, polyethylene emulsion, carboxymethyl cellulose, acrylic polymers, alginates, polyacrylate gums, polyacrylates, microbiocides, oil based defoamers, silicone based defoamers, stilbenes, direct dyes and acid dyes). In a related aspect, such components may provide one or more properties, including but not limited to, building a fine porous structure, providing light scattering surface, improving ink receptivity, improving gloss, binding pigment particles, binding coatings to paper, base sheet reinforcement, filling pores in pigment structure, reducing water sensitivity, resisting wet pick in offset printing, preventing blade scratching, improving gloss in supercalendering, reducing dusting, adjusting coating viscosity, providing water holding, dispersing pigments, maintaining coating dispersion, preventing spoilage of coating/coating color, controlling foaming, reducing entrained air and coating craters, increasing whiteness and brightness, and controlling color and shade. It will be apparent to one of skill in the art that combinations may be varied depending on the property(ies) desired for the final product.

In embodiments, the methods employing the formulations comprising the glyceride/FAS blend may be used to lower the cost of applications of primary/secondary coating (e.g., silicone-based layer, starch-based layer, clay-based layer, PLA-layer, PEI-layer and the like) by providing a layer of material that exhibits a necessary property (e.g., water resistance, low surface energy, and the like), thereby reducing the amount of primary/secondary layer necessary to achieve that same property. In one aspect, materials may be coated on top of a glycerides and/or fatty acid salts layer (e.g., heat sealable agents). In embodiments, the composition is fluorocarbon and silicone free.

In other embodiments, the methods of employing the formulations comprising the glyceride/FAS blend may be used to lower the cost of the coating compositions disclosed by the '073 publication. For example, by using the glyceride/FAS blend, the amount of SFAE can be decreased while still providing a material that exhibits a necessary property (e.g., water resistance, oil and grease resistance, low surface energy, and the like).

In embodiments, the compositions increase both mechanical and thermal stability of the treated product. In one aspect, the surface treatment is thermostable at temperatures between about −100° C. to about 300° C. In further related aspect, the surface of the treated substrate (e.g., a cellulose-based material) exhibits a water contact angle of between about 60° to about 120°. In another related aspect, the surface treatment is chemically stable at temperatures of between about 200° C. to about 300° C.

The substrate, which may be dried prior to application (e.g., at about 80-150° C.), may be treated with the modifying formulations comprising the glyceride/FAE blend by dipping, for example, and allowing the surface to be exposed to the composition for less than 1 second. The substrate may be heated to dry the surface, after which the modified material is ready for use. In one aspect, according to the method as disclosed herein, the substrate may be treated by any suitable coating/sizing process typically carried out in a paper mill (see, e.g., Smook, G., Surface Treatments in Handbook for Pulp & Paper Technologists, (2016), 4^{th} Ed., Cpt. 18, pp. 293-309, TAPPI Press, Peachtree Corners, Ga. USA, herein incorporated by reference in its entirety).

No special preparation of the material is necessary in practicing this disclosure, although for some applications, the material may be dried before treatment. In embodiments, the methods as disclosed may be used on any cellulose-based surface, including but not limited to, a film, a rigid container, fibers, pulp, a fabric or the like. In one aspect, the glyceride/FAE blend or coating agents thereof may be applied by conventional size press (vertical, inclined, horizontal), gate roll size press, metering size press, calender size application, tube sizing, on-machine, off-machine, single-sided coater, double-sided coater, short dwell, simultaneous two-side coater, blade or rod coater, gravure coater, gravure printing, flexographic printing, ink-jet printing, laser printing, supercalendering, and combinations thereof.

Depending on the source, the cellulose treated in the methods herein may be paper, paperboard, pulp, softwood fiber, hardwood fiber, or combinations thereof, nanocellulose, cellulose nanofibres, whiskers or microfibril, microfibrillated, cotton or cotton blends, cellulose nanocrystals, or nanofibrilated cellulose.

In addition, fibers and cellulose-based material modified as disclosed herein, may be repulped. Further, for example, water cannot be easily “pushed” past the low surface energy barrier into the sheet.

In embodiments, the amount of the formulation comprising the glyceride/FAE blend applied is sufficient to completely cover at least one surface of a substrate, such as at least one surface of a cellulose-containing material. For example, in embodiments, the glyceride/FAE blend coating may be applied to the complete outer surface of a container, the complete inner surface of a container, or a combination thereof, or one or both sides of a base paper. In other embodiments, the complete upper surface of a film may be covered by the glyceride/FAE blend coating, or the complete under surface of a film may be covered by the glyceride/FAE blend coating, or a combination thereof. In some embodiments, the lumen of a device/instrument may be covered by the coating or the outer surface of the device/instrument may be covered by the glyceride/FAE blend coating, or a combination thereof.

In embodiments, the amount of glyceride/FAE blend coating applied is sufficient to partially cover at least one surface of a cellulose-containing material. For example, only those surfaces exposed to the ambient atmosphere are covered by the glyceride/FAE blend coating, or only those surfaces that are not exposed to the ambient atmosphere are covered by the glyceride/FAE blend coating (e.g., masking). As will be apparent to one of skill in the art, the amount of glyceride/FAE blend coating applied may be dependent on the use of the material to be covered. In one aspect, one surface may be coated with a glyceride/FAE blend and the opposing surface may be coated with an agent including, but not limited to, proteins, wheat glutens, gelatins, prolamines, soy protein isolates, starches, modified starches, acetylated polysaccharides, alginates, carrageenans, chitosans, inulins, long chain fatty acids, waxes, and combinations thereof. In a related aspect, the glyceride/FAE blend can be added to a furnish, and the resulting material on the web may be provided with an additional coating of glycerides/fatty acid salts.

Any suitable coating process may be used to deliver any of the various glyceride/FAE blend coatings and/or emulsions applied in the course of practicing this aspect of the method. In embodiments, the glyceride/FAE blend coating processes include immersion, spraying, painting, printing, and any combination of any of these processes, alone or with other coating processes adapted for practicing the methods as disclosed.

By increasing the concentration of the glyceride/FAE blend, for example, the composition as disclosed herein may react more extensively with the substrate (e.g., cellulose) being treated with the net result that again improved water-repellent/lipid resistance characteristics are exhibited. However, higher coat weights do not necessarily translate to increased water resistance. In one aspect, various catalysts might allow for speedier “curing” to precisely tune the quantity of the glyceride/FAS blend to meet specific applications

It will be apparent to one of skill in the art that, outside of any particular ranges or compositions described in detail herein, the selection of a cellulose to be treated, the glyceride/FAE blend, the reaction temperature, and the exposure time are process parameters that may be optimized by routine experimentation to suit any particular application for the final product.

The derivatized materials have altered physical properties which may be defined and measured using appropriate tests known in the art. For hydrophobicity the analytical protocol may include, but is not limited to, the contact angle measurement and moisture pick-up. Other properties include, stiffness, WVTR, porosity, tensile strength, lack of substrate degradation, burst and tear properties. A specific standardized protocol to follow is defined by the American Society for Testing and Materials (protocol ASTM D7334-08).

The permeability of a surface to various gases such as water vapour and oxygen may also be altered by the glyceride/FAS blend coating process as the barrier function of the material is enhanced. The standard unit measuring permeability is the Barrer and protocols to measure these parameters are also available in the public domain (ASTM std F2476-05 for water vapour and ASTM std F2622-8 for oxygen).

In embodiments, materials treated according to the disclosed methods display a complete biodegradability as measured by the degradation in the environment under microorganismal attack.

Various methods are available to define and test biodegradability including the shake-flask method (ASTM E1279-89(2008)) and the Zahn-Wellens test (OECD TG 302 B).

Various methods are available to define and test compostability including, but not limited to, ASTM D6400.

Cellulosic materials suitable for treatment by the processes of this disclosure include but are not limited to cotton fibers, plant fibers such as flax, wood fibers, regenerated cellulose (rayon and cellophane), partially alkylated cellulose (cellulose ethers), partially esterified cellulose (acetate rayon), and other modified cellulose materials which have a substantial portion of their surfaces available for reaction/binding. As stated above, the term “cellulose” includes all of these materials and others of similar polysaccharide structure and having similar properties. Among these the relatively novel material microfibrillated cellulose (cellulose nanofiber) (see e.g., U.S. Pat. No. 4,374,702 and U.S. Patent Application Publication Nos. 2015/0167243 and 2009/0221812, herein incorporated by reference in their entireties) is particularly suitable for this application. In other embodiments, celluloses may include but are not limited to, cellulose triacetate, cellulose propionate, cellulose acetate propionate, cellulose acetate butyrate, nitrocellulose (cellulose nitrate), cellulose sulfate, celluloid, methylcellulose, ethylcellulose, ethyl methyl cellulose, hydroxyethyl cellulose, hydroxypropyl cellulose, cellulose nanocrystals, hydroxyethyl methyl cellulose, hydroxypropyl methyl cellulose, ethyl hydroxyethyl cellulose, carboxymethyl cellulose, and combinations thereof.

The modification of the cellulose as disclosed herein, in addition to increasing its hydrophobicity, may also increase its tensile strength, flexibility and stiffness, thereby further widening its spectrum of use. All biodegradable and partially biodegradable products made from or by using the modified cellulose disclosed in this application are within the scope of the disclosure, including recyclable and compostable products.

Among the possible applications of the coating technology disclosed herein such items include, but are not limited to, containers for all purpose such as paper, paperboard, paper pulp, cups, lids, boxes, trays, release papers/liners, compost bags, shopping bags, pipes and water conduits, food grade disposable cutlery, plates and bottles, screens for TV and mobile devices, clothing (e.g., cotton or cotton blends), bandages, pressure sensitive labels, pressure sensitive tape, feminine products, and medical devices to be used on the body or inside it such as contraceptives, drug delivery devices, and the like. Also, the coating technology as disclosed may be used on furniture and upholstery, outdoors camping equipment and the like.

### EXAMPLES

In the following, although embodiments of the present disclosure are described in further detail by means of Examples, the present disclosure is not limited thereto.

### Example 1. Glyceride/FAS Formulations

Formulations were prepared having the compositions listed in Table 1 below, and were coated on bleached lightweight (40#) paper obtained from the University of Maine Process Development Center, Orono, Me. USA at the coating weight listed in Table 2 below.

The coated paper was tested for oil resistance using a 30 second Cobb test, adapted from Tappi Standard Test Method T 441 om-20 “Water Absorptiveness of Paper”, and a 3M KIT Test (Tappi Standard Test Method T 559 “Grease resistance”). Water resistance was tested using a 120 second Cobb test, adapted from Tappi Standard Test Method T 441 om-20 “Water Absorptiveness of Paper”. The results of these tests are found in Table 2 below.

For the 30 second Cobb test, a small volume (2 cc) of vegetable oil was poured rapidly into a 1 inch diameter ring pressed on the coated paper. The milligrams of oil pickup after 30 seconds of contact were measured. The results are reported in gsm.

For the 120 second Cobb test to determine water resistance, a small volume (2 cc) of water was poured rapidly into a 1 inch diameter ring pressed on the coated paper, and the milligrams of water pickup after 120 seconds of contact was measured. The results are reported in gsm.

TABLE 1
SFAE and Glyceride Formulations

| | |
|---|---|
| S-770 | S-770 was obtained from MITSUBISHI CHEMICAL. |
| | S-770 is marketed as ~98% pure sucrose fatty acid ester |
| | (containing stearic acid chains). |
| SE-15 | SE-15 was obtained from HANGZHOU UNION |
| | BIOTECHNOLOGY CO., LTD. SE-15 is marketed as |
| | a sucrose fatty acid ester. SE-15 was analyzed and was |
| | found to actually contain about 15 to 30% by weight |
| | saccharide fatty acid ester, about 40 to 60% by weight |
| | glycerides, and a balance fatty acid salts plus trace |
| | components. |
| SE-15 | SE-15 was subjected to separation to extract its |
| esters | saccharide fatty esters. “SE-15 esters” contains |
| | ~100% by weight of the saccharide fatty acid |
| | esters of SE-15. |
| SE-15 | SE-15 was subjected to separation to extract its |
| water | glycerides. “SE-15 water soluble glycerides” |
| soluble | contains ~100% by weight of the water soluble |
| glycerides | glycerides of SE-15. |
| SE-15 | SE-15 was subjected to separation to extract its |
| water | glycerides. “SE-15 water insoluble glycerides” |
| insoluble | contains ~100% by weight of the water insoluble |
| glycerides | glycerides of SE-15. It was identified that the |
| | water insoluble glycerides comprised tripalmitin |
| | and tristearin. |
| 80 OE | Surfac 80 OE was obtained from TENSAC, S. M. |
| | Tucumán, Argentina. 80 OE is marketed as a food |
| | emulsifier. 80 OE was analyzed and was found to |
| | contain fatty acid salts as the major component, and |
| | also included sucrose, glycerides (primarily mono-, |
| | with trace di- and tri-), and trace amount of sucrose |
| | monoesters. |

TABLE 2
Relative Performance of Glycerides and SFAEs

| | | | Oil | | Water |
|---|---|---|---|---|---|
| | | | Resistance | | Resistance |
| | | | 30 sec. | Oil | 120 sec. |
| | Formula- | Coat Weight | Cobb | Resistance | Cobb |
| Test | tion | (Pounds/Ton) | (gsm) | Kit value | (gsm) |
| 1-1 | Control | 0.0 | 94 | 3- | 36.5 |
| 1-2 | S-770 | 98 | 29 | 6 | 15.5 |
| 1-4 | SE-15 | 108 | 18 | 6 | 18.5 |
| 1-5 | SE-15 | 95 | 24 | 5 | 25.6 |
| | esters | | | | |
| 1-6 | SE-15 | 54 | 56 | 3- | 22.5 |
| | water | | | | |
| | soluble | | | | |
| | glycerides | | | | |
| 1-7 | SE-15 | 133 | 12 | 7/8 | 9.8 |
| | water | | | | |
| | insoluble | | | | |
| | glycerides | | | | |
| 1-8 | 80 OE | 99 | 23 | 5 | 22 |

The results in Table 2 demonstrate that a formulation consisting essentially of glycerides and a formulation consisting essentially of fatty acid salts can be used in the methods of the present disclosure to impart both oil resistance and water resistance to a substrate (here, cellulose fibers).

Further, using substantially the same coating weight as Tests 1-2 to 1-5, Test 1-7 showed a combination of both excellent oil resistance and excellent water resistance. It was unexpected that a formulation consisting essentially of water insoluble (nonpolar, hydrophobic) glycerides would provide both of these properties.

It was observed that the majority of the glycerides were fairly insoluble in hot water. Increasing or lengthening the degree of heating and using agitation did not improve solubility; rather it only increased the likelihood the glycerides would coagulate and float. It is hypothesized that saccharide fatty acid esters can beneficially be used as an emulsifying agent in the formulations of the present disclosure to emulsify the glycerides. Of course, the use of the saccharide fatty acid esters also imparts effects to the treated fiber, as shown by the use of sucrose esters in Test 1-5 above and as described in the '073 publication.

### Example 2. Thermal Forming Method Using Moldable Composition

For Sample 2-1, a 3 gram hand sheet was made using BCTMP (Bleached Chemi-ThermoMechanical Pulp) obtained from Stora Enso. A 120 second oil Cobb test and a 120 second water Cobb test were measured on the obtained hand sheet in the same manner as Example 1, and the results are in Table 3 below.

For Sample 2-2, a 3 gram hand sheet was made in the same manner as Sample 2-1, except that additionally the same SE-15 formulation obtained from HANGZHOU UNION BIOTECHNOLOGY CO., LTD that was used in Example 1 was added to the furnish directly in the hand sheet mold (i.e., the formulation was added to the wet end), along with polyDADMAC (Paraform™ 289 obtained from Paradigm Chemical and Consulting, Ackworth, Ga. USA) as a retention aid. The SE-15 formulation was added in an amount such that the furnish contained about 5% by weight SE-15 based on a dry fiber weight of the BCTMP. The content of polyDADMAC in the furnish was about 0.3% by weight based on a dry fiber weight of the BCTMP. A 120 second oil Cobb test and a 120 second water Cobb test were measured on the hand sheet in the same manner as Example 1, and the results are in Table 3 below.

For Sample 2-3, a 3 gram hand sheet was made in the same manner as Sample 2-2, except that the amount of the SE-15 formulation added to the furnish was increased to about 13% by weight based on a dry fiber weight of the BCTMP, and the amount of polyDADMAC was increased to about 1.3% by weight based on a dry fiber weight of the BCTMP. A 120 second oil Cobb test and a 120 second water Cobb test were measured on the hand sheet in the same manner as Example 1, and the results are in Table 3 below.

The hand sheet obtained in Sample 2-3 was heated to about 250° F., at which point the formed fiber hand sheet became flexible, moldable, and shapeable. The heated composition was then manually formed into a small boat. The hand sheet held and maintained the shape of the boat after cooling to an ambient temperature of about 68° F. to 72° F. A 120 second oil Cobb test and 120 second water Cobb test were measured on the cooled, molded hand sheet in the same manner as Example 1, and the results are in Table 3 below.

TABLE 3
Thermo Forming Results

| | | | Oil | Water |
|---|---|---|---|---|
| | | | Resistance | Resistance |
| | | | 120 sec | 120 sec |
| | SE-15 | | Cobb | Cobb |
| Sample | (wt. %) | polyDADMAC | (gsm) | (gsm) |
| 2-1 | — | — | 127 | >150 |
| 2-2 | 5% | 0.3% | 37.4 | 41.2 |
| 2-3 | 13% | 1.3% | 30.7 | 24.5 |
| (before | | | | |
| heating) | | | | |
| 2-3 | 13% | 1.3% | 30.7 | 24.5 |
| (after | | | | |
| cooling) | | | | |

From the results of Example 2, it was unexpectedly discovered that the use of relatively high levels of the SE-15 formulation (about 10 to 15% (wt/wt) of the total cellulose fiber present in the solution) containing saccharide fatty acid esters, glycerides, and fatty acid salts not only increased both the oil resistance and water resistance performance, but also provided the formed fiber pulp the flexibility to be “melted and molded” as a dry article with addition of sufficient heat. From further testing, it was found that by heating the solid formed article to temperatures above about 150° F., and especially above 250° F., the solid formed article became flexible and was able to be shaped, even without the addition of water. Moreover, upon cooling again, the water and grease resistance properties were retained, as shown in Table 3.

While there have been shown and described fundamental novel features of the disclosure as applied to the preferred and exemplary embodiments thereof, it will be understood that omissions and substitutions and changes in the form and details of the disclosure may be made by those skilled in the art without departing from the spirit of the disclosure. Moreover, as is readily apparent, numerous modifications and changes may readily occur to those skilled in the art. For example, any feature(s) in one or more embodiments may be applicable and combined with one or more other embodiments. Hence, it is not desired to limit the present disclosure to the exact construction and operation shown and described and, accordingly, all suitable modification equivalents may be resorted to falling within the scope of the present disclosure as claimed. In other words, although the embodiments of the disclosure have been described with reference to the above examples, it will be understood that modifications and variations are encompassed within the spirit and scope of the disclosure. Accordingly, the invention is limited only by the following claims.

All references disclosed herein are hereby incorporated by reference in their entireties.

1. A method of imparting a hydrophobic and/or lipophobic barrier properties to a substrate, the method comprising:
preparing a formulation for imparting the hydrophobic and/or lipophobic barrier properties to the substrate, the formulation comprising a blend of one or more glycerides and/or one or more fatty acid salts; and
contacting a surface of the substrate with the formulation to impart the hydrophobic and/or lipophobic barrier properties to the substrate.

2. (canceled)

3. (canceled)

4. The method of claim 1, wherein the step of contacting comprises forming a solution of the formulation and cellulose fiber.

5. (canceled)

6. The method claim 4, further comprising forming a solid article using the solution, the solid article possessing the hydrophobic and/or lipophobic barrier properties.

7. (canceled)

8. The method of claim 1, wherein the step of contacting comprises coating the surface of the substrate with the formulation.

9. (canceled)

10. (canceled)

11. (canceled)

12. The method of claim 1, wherein the one or more glycerides comprises one or more monoglycerides, one or more diglycerides, and one or more triglycerides.

13. The method of claim 1, wherein the one or more glycerides comprises tripalmitin and/or tristearin.

14. (canceled)

15. (canceled)

16. The method of claim 1, wherein the one or more fatty acid salts comprise one or more calcium, potassium or sodium salts.

17. (canceled)

18. (canceled)

19. The method of claim 1, wherein the one or more fatty acid salts comprises one or more selected from the group consisting of sodium oleate, sodium stearate, sodium palmitate, calcium oleate, calcium stearate, and calcium palmitate.

20. (canceled)

21. (canceled)

22. (canceled)

22. The method of claim 1, wherein the formulation further comprises one or more saccharide fatty acid esters.

23. The method of claim 1, wherein the formulation further comprises one or more saccharide fatty acid esters, the substrate comprises cellulose fiber, and a concentration of the saccharide fatty acid esters is 10% (wt/wt) to 25% (wt/wt) of the total cellulose fiber present in the formulation.

24. (canceled)

25. (canceled)

26. (canceled)

27. The method of claim 24, wherein the formulation further comprises one or more pigments, and the one or more pigments have been pre-treated by contacting the pigment with a glyceride, a fatty acid salt, and/or a saccharide fatty acid ester for a sufficient time to bind the glyceride, fatty acid, and/or saccharide to pigment.

28. (canceled)

29. (canceled)

30. (canceled)

31. (canceled)

32. (canceled)

33. The method of claim 1, wherein the formulation further comprises a cationic polymer, and a weight ratio in the formulation of the cationic polymer to the glyceride/FAS blend is from 1:99.9 to 20:80.

34. (canceled)

35. (canceled)

36. (canceled)

37. (canceled)

38. (canceled)

39. (canceled)

40. An emulsion, comprising: 0.01% to 80% by weight of one or more emulsifiers, 0.01% to 95% by weight of a blend of one or more glycerides and/or one or more fatty acid salts, 0.01% to 95% by weight of one or more saccharide fatty acid ester, and a balance of water.

41. The emulsion of claim 40, further comprising 0.01% to 5% by weight of a cationic polymer.

42. A moldable composition, comprising: 75% to 97% by weight cellulose fiber, and a total of 2% to 25% by weight of one or more glycerides, one or more fatty acid salts, and/or one or more saccharide fatty acid esters (SFAE).

43. (canceled)

44. The moldable composition according to claim 42, wherein the moldable composition is flexible and moldable when heated to a temperatures of 150° F. or higher.

45. (canceled)

46. (canceled)

47. A method of thermal forming a molded article having hydrophobic and/or lipophobic barrier properties, the method comprising:
preparing a moldable composition comprising: cellulose fiber, and a blend of one or more glycerides, one or more fatty acid salts, and/or one or more saccharide fatty acid esters;
heating the moldable composition to a temperature of at least 150° F.; and
molding the heated moldable composition into a molded article having a three-dimensional shape,
wherein the molded article possesses the hydrophobic and/or lipophobic barrier properties.

48. The method of claim 47, wherein the molded article retains its shape upon cooling to ambient temperature.

49. The method of claim 47, wherein the moldable composition comprises 75% to 97% by weight cellulose fiber, and 2% to 25% by weight of one or more glycerides, one or more fatty acid salts, and/or one or more saccharide fatty acid esters (SFAE).

50. (canceled)

51. (canceled)

52. (canceled)

53. (canceled)

54. (canceled)

55. (canceled)

56. (canceled)

57. (canceled)

58. (canceled)

59. (canceled)

60. The method of claim 47, wherein a surface of the molded article exhibits a water contact angle of at least 90°.

61. (canceled)
